(19) United States
(12) Patent Application Publication
(10) Pub. No.: US 2015/0305551 A1
(43) Pub. Date: Oct. 29, 2015

(54) BEVERAGE APPLIANCE FOR USE WITH A REMOTE COMMUNICATION DEVICE

(71) Applicant: Spectrum Brands, Inc., Middleton, WI (US)

(72) Inventors: Daniele Rosati, Verona, WI (US); Kurt Ryan Rottier, Beaver Dam, WI (US); Timothy Nott, Madison, WI (US); Dominic DiMarco, Madison, WI (US); Cassandra M. Schuette, Madison, WI (US)

(21) Appl. No.: 14/657,669

(22) Filed: Mar. 13, 2015

Related U.S. Application Data
(60) Provisional application No. 62/129,425, filed on Mar. 6, 2015.
(60) Provisional application No. 61/953,050, filed on Mar. 14, 2014.

(51) Int. Cl. A47J 31/56; A23F 5/26; A23F 3/18; A47J 31/46

(52) U.S. Cl. CPC A47J 31/56; A47J 31/462; A23F 5/26; A23F 3/18

(57) ABSTRACT

Systems, apparatuses, methods, and computer-readable storage media related to beverage appliances and remote communication devices are provided. One example beverage appliance includes a sensor configured to detect an operational characteristic of the beverage appliance and a controller coupled to the sensor. The controller is configured to send a signal indicative of the detected operational characteristic to a remote communication device. One example method for operating a beverage appliance using a remote communication device includes receiving a selection of at least one setting for a beverage operation, transmitting the at least one setting to the beverage appliance, receiving at least one of beverage data and operational data from the beverage appliance, determining when the beverage operation is complete, generating an alert when the beverage operation is complete, and displaying, on a display device of the remote communication device, an indicator of the time since the completion of the beverage operation.

### CROSS REFERENCE TO RELATED APPLICATIONS

This application claims priority to U.S. Ser. No. 61/953,050, titled BEVERAGE APPLIANCE FOR USE WITH A REMOTE COMMUNICATION DEVICE, filed on Mar. 14, 2014, and U.S. Ser. No. 62/129,425 titled BEVERAGE APPLIANCE FOR USE WITH A REMOTE COMMUNICATION DEVICE, filed Mar. 6, 2015, the disclosures of which are hereby incorporated by reference in their entireties.

### BACKGROUND

Beverage appliances, such as electronic coffee makers, electronic tea kettles, and cappuccino makers often require a user of the appliance to remain close to the appliance. Some cooking operations may be performed by the appliance without requiring significant action by the user. For example, after a coffee maker is set up by a user, the coffee maker can brew a pot of coffee without intervention by the user. Similarly, after water is added to an electric tea kettle and the tea kettle is turned on, the user is not needed for the period of time during which the tea kettle is heating the water. However, if the user does not remain close to the appliance the user may not know when the expected time to heat the water or brew the pot of coffee has elapsed, and may not hear or see an indication from the appliance that the time has elapsed or that the brewing cycle has been completed.

Moreover, a user of an appliance may prefer to delay an operation of the appliance. For example, the user may prefer to prepare a coffee maker to brew a pot of coffee at night and delay the start time for brewing the pot of coffee until the next morning. Oftentimes, a user must be within a specific vicinity of the appliance in order to start the coffee maker and/or to set a later start time for the brewing of the pot of coffee.

It may be advantageous to provide a user with systems, methods, and computer-readable media to provide information to a user of an appliance locally and or remotely, and/or to provide the user with additional control over the appliance.

### SUMMARY

The present disclosure generally relates to cooking appliances. More specifically, the present disclosure relates to beverage appliances, such as electronic coffee makers, electronic tea kettles, and cappuccino makers, and remote communication devices, such as mobile phones, portable computers, tablet computers, personal digital assistants, etc.

In one aspect of the present disclosure, a beverage appliance includes a heating element, a sensor configured to detect an operational characteristic of the beverage appliance, and a controller coupled to the sensor. The controller is configured to send a signal indicative of the detected operational characteristic to a remote communication device.

In another aspect of the present disclosure, a beverage appliance includes a fluid system configured for at least one of receiving fluid from a source of fluid and retaining fluid. A sensor is configured to detect an operational characteristic of the beverage appliance. A controller is coupled to the sensor and configured to send a signal indicative of the detected operational characteristic to a remote communication device.

Another aspect of the disclosure is a beverage appliance. The beverage appliance includes a heating element and a controller. The controller includes a communication interface configured to receive settings from a remote communication device. The controller is configured to control the heating element based at least in part on the settings received from the remote communication device.

Another aspect of the disclosure is a beverage appliance. The beverage appliance includes a fluid system configured for at least one of receiving fluid from a source of fluid and retaining fluid. A controller includes a communication interface configured to receive settings from a remote communication device.

In another aspect of the disclosure, a remote communication device for use with a beverage appliance is provided. The remote communication device includes a display device, a processor, and a memory coupled to the processor. The memory stores instructions that, when executed by the processor, cause the processor to: receive a user's selection of at least one setting for a beverage operation using the beverage appliance, transmit the at least one setting to the beverage appliance, receive at least one of beverage data and operational data from the beverage appliance, determine when the beverage operation is complete, and display, on the display device, an alert when the beverage operation is complete.

In another aspect, a coffee maker comprising: a heating element; a reservoir configured to retain a fluid; and a controller including a communication interface configured to receive instructions from a remote communication device, the controller configured to cause the beverage appliance to perform beverage operations in response to instructions received from the remote communication device.

A method for operating a beverage appliance using a remote communication device, the method comprising: receiving, on the remote communication device, a selection of at least one setting for a beverage operation using the beverage appliance; transmitting the at least one setting to the beverage appliance; receiving at least one of beverage data and operational data from the beverage appliance; determining when the beverage operation is complete; generating an alert when the beverage operation is complete; and displaying, on a display device of the remote communication device, an indicator of the time since the completion of the beverage operation.

A computer-readable storage medium storing computer-executable instructions that, when executed by a processor of a remote communication device, cause the remote communication device to: receive a selection of at least one setting for the beverage operation using the beverage appliance; transmit at least one setting to the beverage appliance; receive at least one of beverage data and operational data from the beverage appliance; determine when the beverage operation is complete; display an alert when the beverage operation is complete; and display an indicator of the time since the completion of the beverage operation.

The features, functions, and advantages described herein may be achieved independently in various implementations described in the present disclosure or may be combined in yet other implementations, further details of which may be seen with reference to the following description and drawings.

### BRIEF DESCRIPTION OF THE DRAWINGS

FIG. 1 is an exemplary system having a beverage appliance and a remote communication device;

FIG. 2 is an exemplary computing device;

FIG. 3 is a block diagram of the beverage appliance shown in FIG. 1;

FIG. 4 is functional block diagram of the exemplary system shown in FIG. 1;

FIG. 5 is a flow diagram of a method for using a beverage appliance with a remote communication device;

FIG. 6 is a flow diagram of another method for using a beverage appliance with a remote communication device;

FIG. 7 is a flow diagram of yet another method for using a beverage appliance with a remote communication device;

FIGS. 8 and 9 are example displays of the remote communication device shown in FIG. 1;

FIG. 10 is another exemplary system having a beverage appliance and a remote communication device;

FIG. 11 is an example display of the remote communication device shown in FIG. 10.

FIG. 12 is an example display of the remote communication device shown in FIG. 10.

FIG. 13 illustrates an example beverage appliance of FIG. 1.

FIG. 14 illustrates another example beverage appliance of FIG. 1.

FIG. 15 is a flowchart illustrating an example method of operating the remote communication device network configuration component of FIG. 4.

FIG. 16 illustrates an example home screen displayed by some embodiments of the remote communication device of FIG. 1.

FIG. 17 illustrates another example home screen displayed by some embodiments of the remote communication device of FIG. 1.

FIG. 18 illustrates another example home screen displayed by some embodiments of the remote communication device of FIG. 1.

FIG. 19 is another illustration of the example home screen of FIG. 16 displaying a notification message.

FIG. 20 is another illustration of the example home screen of FIG. 16 displaying a notification message.

FIG. 21 is another illustration of the example home screen of FIG. 17 displaying a notification message.

FIG. 22 is another illustration of the example home screen of FIG. 18 displaying a notification message.

FIG. 23 illustrates an example menu screen displayed by some embodiments of the remote communication device of FIG. 1.

FIG. 24 illustrates an example settings screen displayed by some embodiments of the remote communication device of FIG. 1.

FIG. 25 illustrates an example appliances screen displayed by some embodiments of the remote communication device of FIG. 1.

FIG. 26 illustrates another example appliances screen displayed by some embodiments of the remote communication device of FIG. 1.

FIG. 27 illustrates an example schedule management screen displayed by some embodiments of the remote communication device of FIG. 1.

FIG. 28 illustrates an example edit schedule screen displayed by some embodiments of the remote communication device of FIG. 1.

Although specific features of various embodiments may be shown in some drawings and not in others, this is for convenience only. Any feature of any drawing may be referenced and/or claimed in combination with any feature of any other drawing. Corresponding reference characters indicate corresponding parts throughout the drawings.

### DETAILED DESCRIPTION

The present disclosure generally relates to beverage appliances that communicate with a remote communication device. The beverage appliances are appliances used to heat and prepare beverages. The beverage appliances are configured to send data to the remote communication device.

The data that the beverage appliances send to the remote communication device includes, for example, beverage data, operational data for the beverage appliance, and maintenance and/or error data concerning the beverage appliance. Example beverage data includes the weight of the water, ingredients (such as ground coffee, tea, etc.), and/or beverage placed within a compartment associated with the beverage appliance, and/or the temperature of water, ingredients, or beverage within a compartment associated with the beverage appliance. Operational data for the beverage appliance can include a temperature of a component and/or container associated with the beverage appliance, an air temperature within the beverage appliance, a status of the beverage appliance (e.g., on or off, delayed start, preheating, cleaning cycle, etc.), the current settings of the beverage appliance, and the like. Maintenance and error data includes data concerning suggested or required maintenance procedures (e.g., cleaning a filter, draining a drip pan, descaling), and identification of errors and possible solutions. Maintenance and error data may also include historical usage data such as the number of on/off or beverage making cycles performed by the beverage appliance 102. Additionally, the maintenance and error data may include the types of beverage making operations performed with the beverage appliance 102 and the number of times each type of beverage making operation has been performed.

The remote communication device is configured, such as by suitable programming, to communicate with the beverage appliance. Specifically, the remote communication device is configured to receive data from the beverage appliance and display the data to the user. In some embodiments, the remote communication device is configured to allow the user to remotely control at least some aspects of the beverage appliance. For example, the remote communication device may be configured to be able to turn the beverage appliance on and off, set a timer on the beverage appliance, change/set one or more settings of the beverage appliance (e.g., set temperature), and/or instruct the beverage appliance to perform a series of actions.

The remote communication device is configured to be able to inform and alert a user based on data received from the beverage appliance and/or user settings. For example, the user can set a timer on the portable communication device to be alerted when a beverage should be done (according to the recipe). The portable communication device can alert the user, based on data received from the beverage appliance, when the beverage appliance reaches a specified condition, such as a specified temperature, or when the beverage within a container of the beverage appliance reaches a certain temperature.

Additional aspects of the present disclosure relate to interactive instructions and/or recipes. The remote communication device can store, import, and/or retrieve recipes that utilize the beverage appliance and instructions for using the beverage appliance. Recipes may simply be displayed to the user or may interact with the user and/or the beverage appliance (via the remote communication device). For example, when a user selects an interactive recipe, the settings of the beverage appliance to prepare the recipe (e.g., the temperature, the length of time, etc.) may be transmitted and applied to the beverage appliance. When a recipe includes multiple steps, the interactive recipe may step the user through the steps of the recipe as each step is completed. The remote communication device can determine when a step is completed based on data received from the beverage appliance and/or based on the user indicating that a step is completed.

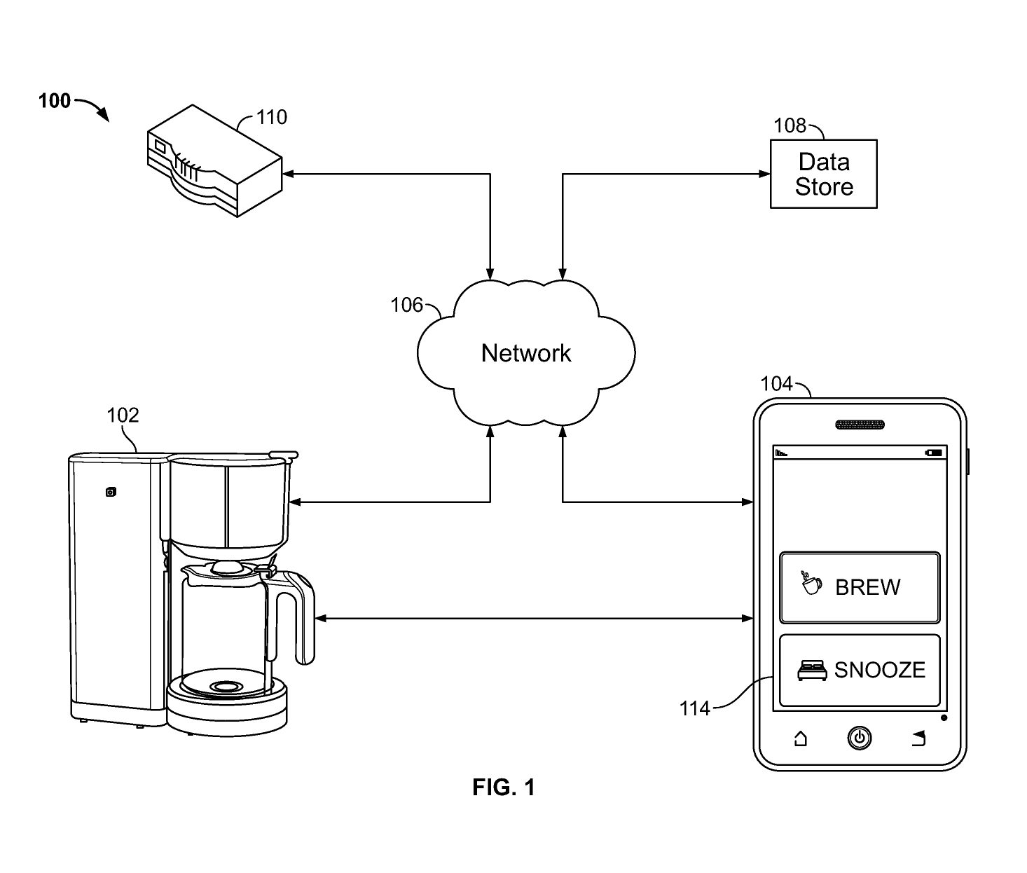

FIG. 1 is an illustration of an example system 100 having a beverage appliance 102 and a remote communication device 104. The remote communication device 104 is communicatively coupled to the beverage appliance 102 directly and/or via a network 106. A data store 108 is communicatively coupled with the beverage appliance 102 and the remote communication device 104 via the network 106. The network 106 may be formed at least in part by the router 110, which may facilitate communication between one or more of the beverage appliance 102, the remote communication device 1024, and the data store 108.

In the embodiment shown in FIG. 1, the beverage appliance 102 is a coffee maker. In other embodiments, the beverage appliance 102 is an electric tea kettle. In other embodiments, the beverage appliance is a single serve coffee maker for brewing with coffee cups, pods, packs, etc. In additional embodiments, the beverage appliance 102 is any other suitable heated appliance for preparing a beverage such as but not limited to a cappuccino maker. The beverage appliance 102 is configured to communicate with the remote communication device 104 by suitable programming loaded onto the beverage appliance 102.

A remote communication device, as used herein, is a device that is separate from the beverage appliance 102 and that is capable of receiving communication from the beverage appliance 102. In the exemplary embodiment, the remote communication device 104 is a mobile phone. In other embodiments, the remote communication device 104 is a desktop computer, a tablet computer, a laptop computer, a television, a radio, a personal digital assistance, a pager, any other suitable communication device, or any combination thereof. Additionally, in some embodiments, the remote communication device 104 is a device specifically dedicated to the beverage appliance 102 such that the remote communication device 104 is configured to communicate specifically with the beverage appliance. Although only one remote communication device is shown in FIG. 1, it is contemplated that more than one remote communication device 104, including different types of remote communication devices, may be used with system 100. The remote communication device 104 is configured to communicate with the beverage appliance 102 by suitable programming loaded onto the remote communication device 104. In some embodiments, an application 114 (sometimes referred to as an “app”) is downloaded and/or installed on the remote communication device 104. The installed application 114 configures the remote communication device to communicate with the beverage appliance 102 and otherwise function as described herein.

The beverage appliance 102 communicates with the remote communication device 104 directly and/or by utilizing network 106. The beverage appliance 102 communicates with the remote communication device 104 using any suitable wired or wireless communication protocol. For example, the beverage appliance 102 may communicate with the remote communication device using, along with appropriate communication protocols, a radio frequency (RF) transceiver, a Bluetooth® adapter, a Wi-Fi transceiver, a ZigBee® transceiver, a near field communication (NFC) transceiver, an infrared (IR) transceiver, and/or any other device capable of communicating directly with remote communication device 104 (Bluetooth is a registered trademark of Bluetooth Special Interest Group of Kirkland, Wash.; ZigBee is a registered trademark of the ZigBee Alliance of San Ramon, Calif.). Wired communication between the beverage appliance 102 and the remote communication device 104 may use any suitable wired communication protocol including, without limitation, USB, RS232, I2C, SPI, analog, and proprietary I/O protocols.

The network 106 is a communication network. In an exemplary embodiment, the network 106 is a wireless local area network (WLAN). The network 106 may be any suitable type of network and/or a combination of networks. The network 106 may be wired or wireless and of any communication protocol. The network 106 may include, without limitation, the Internet, a local area network (LAN), a wide area network (WAN), a wireless LAN (WLAN), a mesh network, a virtual private network (VPN), a cellular network, and/or any other network that allows system 100 to operate as described herein.

The data store 108 is configured to store data associated with the beverage appliance 102 and/or the remote communication device 104. Such data may include beverage data, operational data for the beverage appliance 102, and maintenance and/or error data concerning the beverage appliance 102. The data store 108 may also store instructions and/or recipes for use with the beverage appliance 102. Although a single data store 108 is shown in FIG. 1, system 100 may include one or multiple data stores. The data store 108 may be a standalone data store (e.g., a part of a server connected to network 106), may be located within beverage appliance 102, and/or may be located within the remote communication device 104. Moreover, the data store 108 may be a distributed data store that exists across multiple computers, devices, and/or locations.

The router 110 is a networking device that provides a connection between the beverage appliance 102 and the remote communication device 104 and forwards data packets therebetween. In some embodiments, the router 110 is configured to implement a network such as a wireless local area network (WLAN). In some embodiments, the router 110 operates as an access point to the network 106. In some embodiments, however, communication can occur directly between the beverage appliance 102 and the remote communication device 104, and the router 110 is either not included, or is a component of either the beverage appliance 102 or the remote communication device 104.

As indicated above, aspects of the present disclosure relate to beverage appliances that communicate with a remote communication device. In FIG. 1 the beverage appliance 102 is a coffee maker. As will be described further within this disclosure, a remote communication device, such as a mobile phone, can be used to control operations of the coffee maker. For instance, a coffee maker may send an indication to the mobile phone that the coffee maker is scheduled to begin brewing a pot of coffee. The mobile phone may present this indication to the user and allow the user to select an option to proceed with brewing the pot of coffee or to delay the brewing for a specific amount of time. A user may provide additional selections and instructions through the mobile phone to the coffee maker, such as a type of brew (e.g., dark roast, medium roast, light roast), a type of coffee or other beverage (i.e., tea), a programming for future brews or other operations, a selected amount of time to keep the pot of coffee at a desired temperature, on and off times, a scheduled cleaning time, etc.

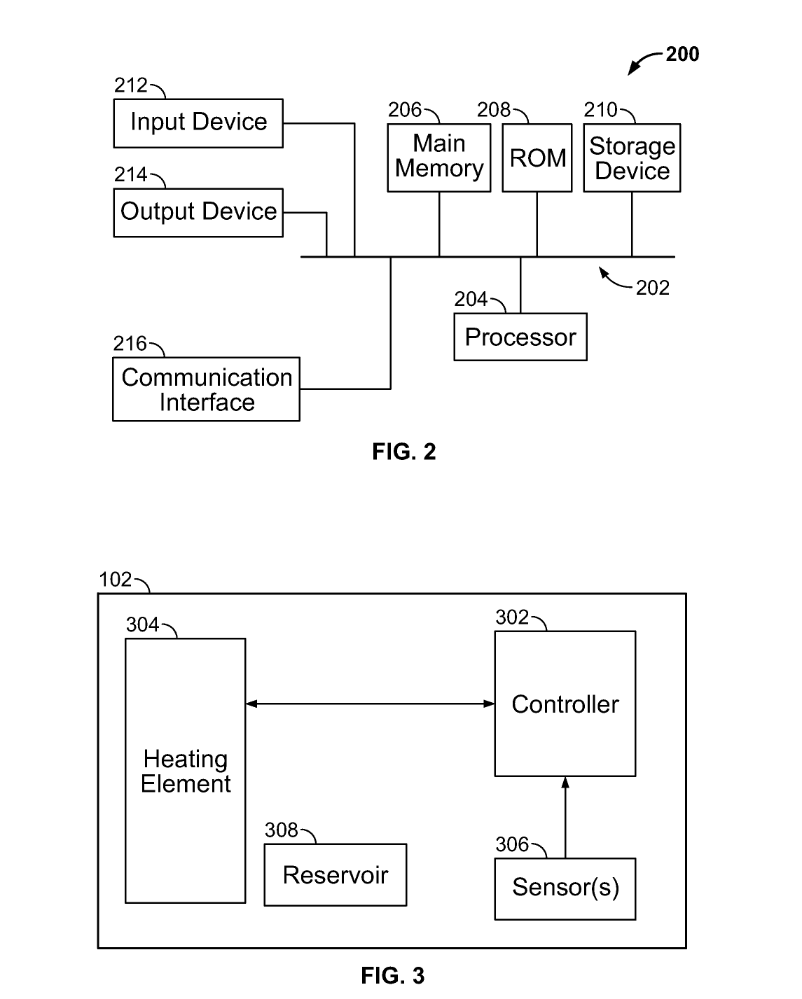

Various embodiments described in this disclosure include computing devices. FIG. 2 shows an example of a computing device 200 intended to represent various forms of digital computers, such as laptops, desktops, workstations, personal digital assistants, servers, blade servers, mainframes, and other appropriate computers. Computing device 200 is also intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

In the exemplary embodiment, beverage appliance 102 and remote communication device 104 (shown in FIG. 1) each include a computing device 200. Computing device 200 includes a bus 202, a processor 204, a main memory 206, a read only memory (ROM) 208, a storage device 210, an input device 212, and output device 214, and a communication interface 216. Bus 202 includes a path that permits communication among the components of computing device 200.

Processor 204 includes any type of conventional processor, microprocessor, or processing logic that interprets and executes instructions. Processor 204 can process instructions for execution within the computing device 200, including instructions stored in the main memory 206 or on the storage device 210 to display graphical information for a GUI on an external input/output device, such as a display coupled to a high speed interface. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

Main memory 206 may include a random access memory (RAM) or another type of dynamic storage device that stores information and instructions for execution by processor 204. Main memory 206 stores information within the computing device 200. In one implementation, main memory 206 is a volatile memory unit or units. In another implementation, main memory 206 is a non-volatile memory unit or units. Main memory 206 may also be another form of computer-readable medium, such as a magnetic or optical disk.

ROM 208 may include a conventional ROM device or another type of static storage device that stores static information and instructions for use by processor 204.

The storage device 210 includes any available computer-readable media that can be accessed by the computing device 200. By way of example, computer-readable media include computer-readable storage media and computer-readable communication media.

The storage device 210 is capable of providing storage for the computing device 200. Computer-readable storage media includes volatile and nonvolatile, removable and non-removable media implemented in any device configured to store information such as computer-readable instructions, data structures, program modules or other data. Computer-readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 200. Computer-readable storage media does not include computer-readable communication media.

Computer-readable communication media typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer-readable communication media includes wired media such as a wired network or direct-wired connection, and wireless media such as acoustic, radio frequency, infrared, and other wireless media. Combinations of any of the above are also included within the scope of computer-readable media.

Input device 212 includes a conventional mechanism that permits computing device 200 to receive commands, instructions, or other inputs from a user, including visual, audio, touch, button presses, stylus taps, etc. Additionally, input device 212 may receive location information. Accordingly, input device 212 may include, for example, a camera, a microphone, one or more buttons, a touch screen, and/or a GPS receiver. Output device 214 may include a conventional mechanism that outputs information to the user, including a display (including a touch screen) and/or a speaker. Communication interface 216 may include any transceiver-like mechanism that enables computing device 200 to communicate with other devices and/or systems. For example, communication interface 216 may include mechanisms for communicating with another device or system directly or via a network, such as network 106 (shown in FIG. 1).

As described herein, computing device 200 facilitates the presentation of content, such as an instruction, along with beverage data, operational data for the beverage appliance, and maintenance and/or error data. Computing device 200 may perform these and other operations in response to processor 204 executing software instructions contained in a computer-readable medium, such as main memory 206. A computer-readable medium may include a physical or logical computer-readable memory device and/or carrier wave. The software instructions may be read into main memory 206 from another computer-readable medium, such as data storage device 210, or from another device via communication interface 216. The software instructions contained in main memory 206 may cause processor 204 to perform processes described herein. Alternatively, hardwired circuitry may be used in place of or in combination with software instructions to implement processes consistent with the principles of the subject matter disclosed herein. Embodiments are not limited to any specific combination of hardware circuitry and software.

The processor 204 can execute instructions within the computing device 200, including instructions stored in the main memory 206. The processor may be implemented as chips that include separate and multiple analog and digital processors. The processor may provide, for example, for coordination of the other components of the computing device 200, such as control of user interfaces, applications run by computing device 200, and wireless communication by computing device 200.

Computing device 200 may communicate wirelessly through communication interface 216, which may include digital signal processing circuitry where necessary. Communication interface 216 may provide for communications under various modes or protocols, such as GSM voice calls, SMS, EMS, or MMS messaging, CDMA, TDMA, PDS, WCDMA, CDMA2000, or GPRS, among others. Such communication may occur, for example, through radio-frequency transceiver. In addition, short-range communication may occur, such as using a Bluetooth®, WiFi, or other such transceiver(s) (not shown). In addition, a GPS (Global Position system) receiving module may provide additional navigation- and location-related data to computing device 200, which may be used as appropriate by applications running on computing device 200.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

FIG. 3 is a simplified block diagram of the beverage appliance 102. The beverage appliance 102 includes a controller 302, a heating element 304, a sensor 306, and a fluid reservoir 308. Except as otherwise described herein, the controller 302 is substantially identical to the computing device 200. In other embodiments, the controller 302 is any other analog circuitry, digital circuitry, or analog and digital circuitry configured to operate as described herein. Although the controller 302 is illustrated within the beverage appliance 102, the controller 302 may be integrated with the beverage appliance 102 or removably coupled with the beverage appliance 102. Moreover, the controller 302 may be implemented partially integrated with the beverage appliance 102 and partially removably coupled with the beverage appliance 102. As FIG. 3 is a simplified block diagram, not all components that are present in beverage appliance 102 (e.g., wires, switches, relays, power supplies, etc.) are illustrated in FIG. 3.

Heating element 304 provides, under the control of the controller 302, the heat for preparing a beverage with the beverage appliance 102. Although a single heating element 304 is shown, beverage appliance 102 may include any number of heating elements 304 suitable to permit beverage appliance 102 to prepare a beverage. For example, the beverage appliance 102 may include a first heating element for heating the water in the fluid reservoir 308 used to brew coffee and a second heating element for warming a coffee pot containing brewed coffee.

Sensor 306 is a temperature sensor configured to detect a temperature of a component associated with the beverage appliance 102 and/or a beverage within the component. In the example embodiment, the sensor 306 detects the temperature of water in a fluid reservoir 308 of the beverage appliance 102 which is used in preparing a beverage. The sensor 306 provides a signal indicative of the detected temperature to the controller 302. The controller 302 uses the detected signal as feedback for controlling the beverage appliance 102. The controller 302 may also determine the temperature based on the signal and present the temperature to a user through output device 214 (shown in FIG. 2) and/or by transmission to remote communication device 104. In other embodiments, sensor 306 is any other sensor that detects an operational characteristic of beverage appliance 102 to produce operational data about beverage appliance 102 or that detects a characteristic of a beverage associated with the beverage appliance 102. Example sensor types include weight sensors configured to detect the weight of an item placed on/in the beverage appliance 102, position sensors configured to detect the relative position or orientation of the beverage appliance 102 or a portion of the beverage appliance 102 (e.g., opened/closed, upside down), moisture sensors to detect the presence and/or amount of moisture, and ambient temperature sensors. Moreover, although one sensor 306 is illustrated, beverage appliance 102 may include any suitable number of similar or different sensors 306.

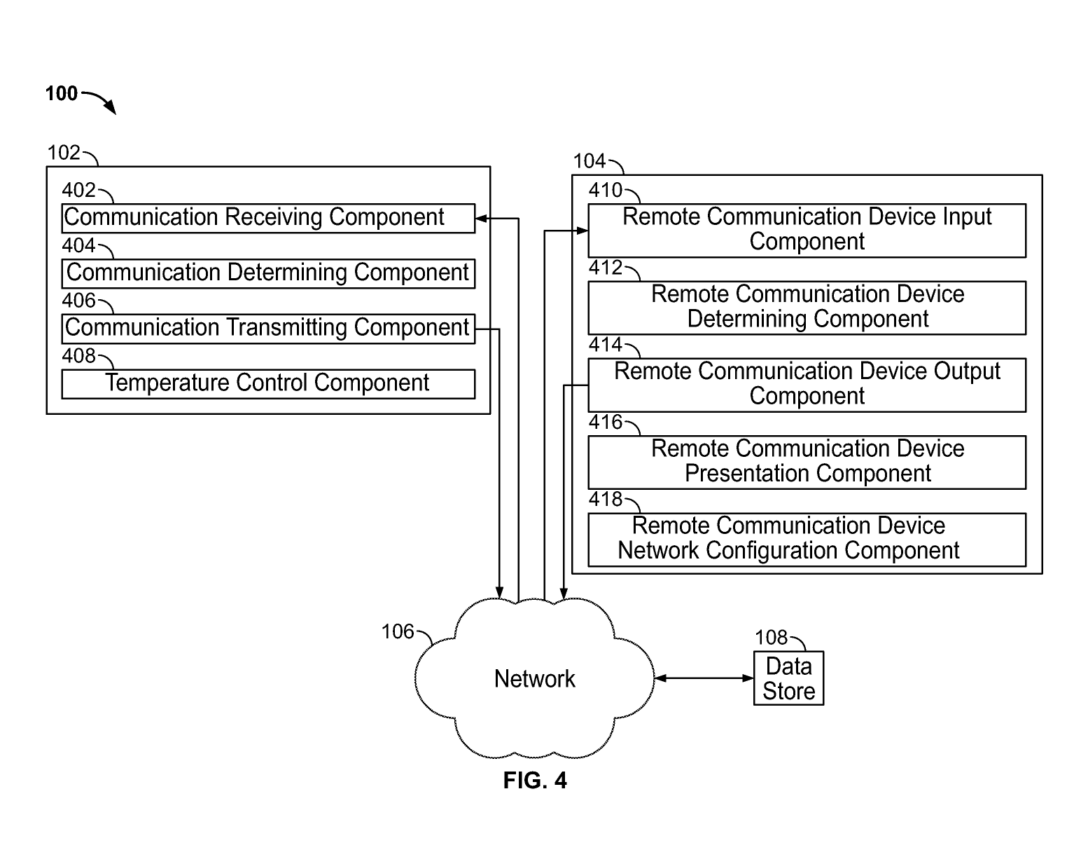

Turning to FIG. 4, a functional block diagram of an embodiment of system 100 includes the beverage appliance 102, the remote communication device 104, the network 106, and the data store 108. The other structural components of the system 100 shown in FIGS. 1-3, while still included as part of system 100, are not shown in the functional diagram of FIG. 4.

The beverage appliance 102 includes multiple components that may be, for example, part of controller 302 and may be embodied in one or more software modules executed by controller 302. The beverage appliance 102 includes a communication receiving component 402, a communication determining component 404, and a communication transmitting component 406, and a temperature control component 408. Communication receiving component 402 receives data, such as beverage data, operational data, and maintenance and/or error data. Moreover, communication receiving component 402 receives data and instructions from a remote communication device 104 and input device 212. The communication determining component 404 is configured to calculate, compare, and determine results based on inputs, such as from the communication receiving component 402. For example, the communication determining component determines a temperature based on a signal representative of the temperature received from sensor 306 (shown in FIG. 3). Communication transmitting component 406 is configured to output received data and/or determined values to output device 214, to data store 108, and/or to remote communication device 104. The temperature control component 408 controls the heating element 304 (shown in FIG. 3) based on data from sensor 306 and user inputs. Thus, the user may set a desired temperature for the beverage appliance 102 via the input device 212 or the remote communication device 104 and the temperature control component 408 operates the heating element 304 to achieve the desired temperature.

As described above, the remote communication device 104 may be a mobile phone, a tablet computer, a desktop computer, a television, a radio, a personal digital assistance, a pager, and/or any other suitable communication device. The remote communication device 104 includes multiple components that may be, for example, part of a computing device 200 and may be embodied in one or more software modules executed by the computing device 200.

The remote communication device 104 is configured to receive data, such as beverage data, operational data, and maintenance and/or error data from the beverage appliance 102. The remote communication device 104 includes a remote communication device input component 410, a remote communication device determining component 412, a remote communication device output component 414, a remote communication device presentation component 416, and a remote communication device network configuration component 418.

The remote communication device input component 410 is configured to receive data from beverage appliance 102 and to retrieve data from other components within system 100, such as data store 108. In some embodiments, the remote communication device input component 410 retrieves recipe data and/or instructions from data store 108. Recipe data may include, but is not limited to, recipes stored on the data store 108 and instructions associated with the recipes. An instruction associated with a recipe may include a specific amount of fluid to be added to a fluid reservoir of the beverage appliance 102, a temperature at which to heat a fluid reservoir, a length of time to maintain a temperature of a prepared beverage, and the like. Remote communication device input component 410 is also configured to receive a selection of an item, such as a selection of a recipe, by a user.

The remote communication device determining component 412 is configured to calculate, compare, or determine results based on inputs, such as from the remote communication device input component 410. For example, the remote communication device determining component 412 determines a temperature of the beverage appliance 102 based on a signal from the beverage appliance 102 received through the remote communication device input component 410. The remote communication device determining component 412 also compares detected temperatures to setpoint temperatures to determine, for example, whether or not the beverage appliance 102 is at the desired temperature, whether or not the beverage within a component of the beverage appliance 102 is at the desired temperature, whether or not a predetermined length of heating time has elapsed, etc.

The remote communication device output component 414 is configured to output data to the remote communication device presentation component 416, to the data store 108, and/or to the beverage appliance 102. The remote communication device presentation component 416 is configured to display (present) data, such as recipes, instructions, beverage data, operational data, and error/maintenance data to the user on the output device 214 of the remote communication device 104.

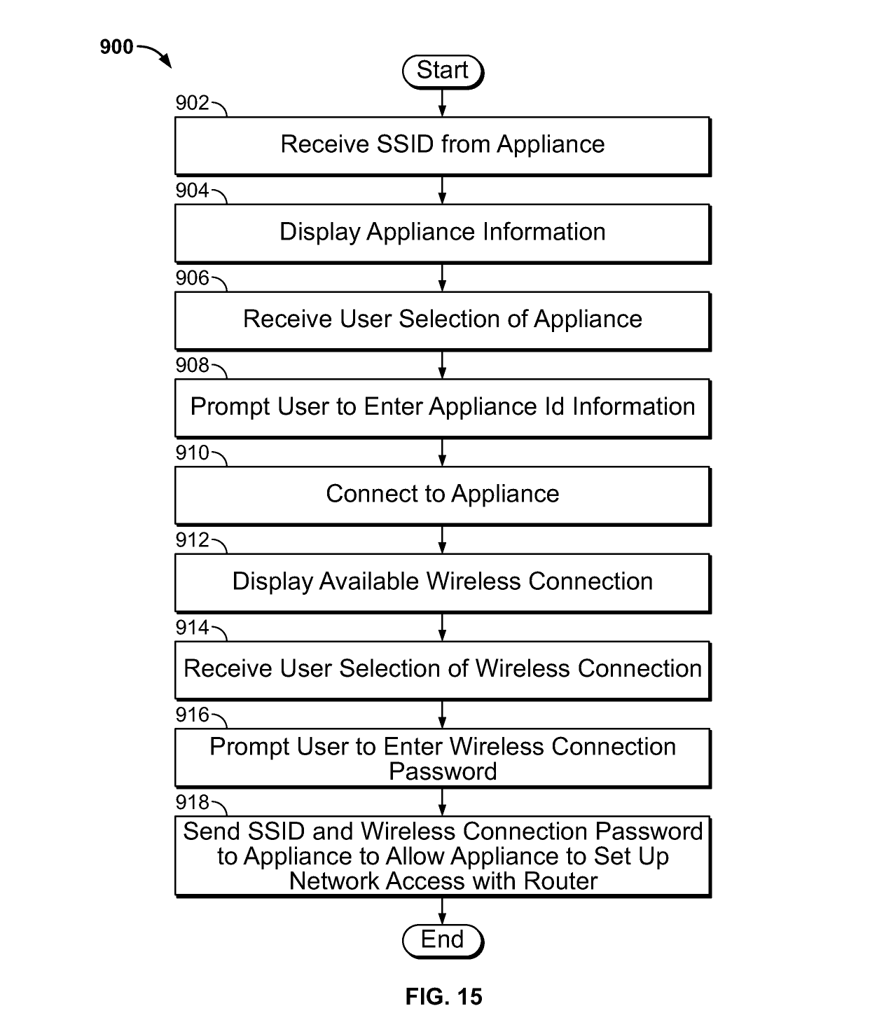

The remote communication device network configuration component 418 operates to establish a wireless connection between the beverage appliance 102 and the remote communication device 104. An example operation of the remote communication device network configuration component 418 is illustrated and described with reference to FIG. 15.

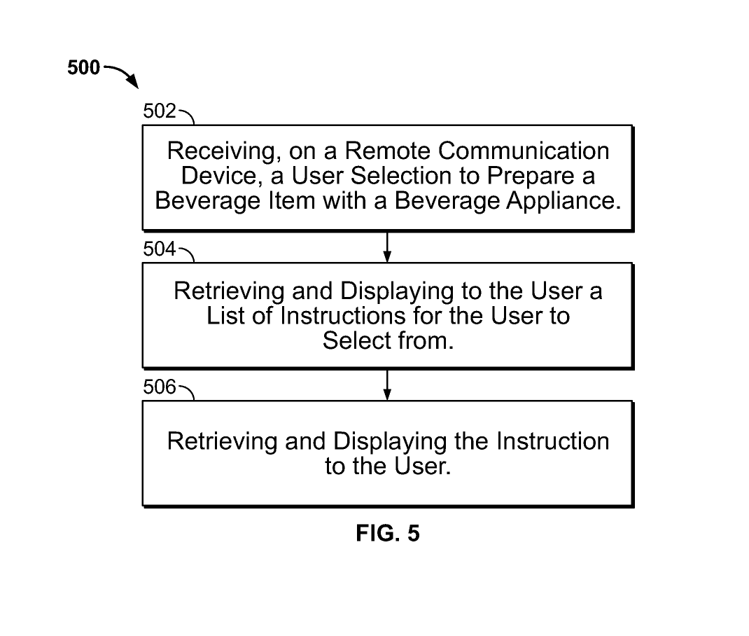

FIGS. 5-7 are flow diagrams of several methods for using a beverage appliance with a remote communication device. Although, the methods will be described with reference to the components of the system 100, the methods may be performed using any suitable system including beverage appliance 102 and remote communication device 104. The methods described herein may be performed by the remote communication device 104 and/or beverage appliance 102 using hardware, software, or a combination of hardware and software. Moreover, the methods may be performed by the components described with reference to FIG. 4. Further, the methods, or portions of the methods, described herein may be performed using a software application (such as the application 114) loaded onto the remote communication device 104 that specifically configures the remote communication device 104 to perform at least some steps of the methods.

FIG. 5 is a flow diagram of a method 500 for preparing a beverage with beverage appliance 102. The method 500 includes receiving 502, on remote communication device 104, a user selection to prepare a beverage with the beverage appliance 102. The remote communication device 104 retrieves and displays to the user, at 504, a list of instructions for the user to select from. The instructions are a list of beverages that may be prepared using the beverage appliance 102. The types and number of beverages listed varies depending on the type of beverage appliance. For example, a coffee maker may simply display an option to brew coffee, while an electric tea kettle may display instructions for multiple types of teas (e.g., green tea, white tea, black tea, herbal tea, etc.). Moreover, in some embodiments, the instructions include recipes for preparing more complicated beverages using the beverage appliance (e.g., iced coffee, cappuccino, latte, chai tea, iced tea, etc.). The instructions may be sorted and displayed to the user according to any suitable organization, including alphabetical ordering, grouping by beverage type, ordered by length of time required to prepare, etc. Moreover, in some embodiments, the remote communication device 104 also displays to the user a search box, through which the user may search for a particular beverage, recipe, and/or instruction.

At 506, when the user selects an instruction, the remote communication device 104 retrieves and displays the instruction to the user. The instruction identifies the settings for the beverage appliance 102 to prepare the selected beverage/recipe, the time required, and/or the sequence of steps to prepare the item. The sequence of steps may be simple (e.g., heat water to selected temperature and brew coffee with the water) or more complex (e.g., heat water to a selected temperature, pour water from the fluid reservoir over tea leaves (or add tea leaves to water), and let beverage steep for 2 minutes, remove tea leaves). After the instructions are provided, the user may apply the appropriate settings to the beverage appliance 102 and prepare the beverage/recipe according to the instructions.

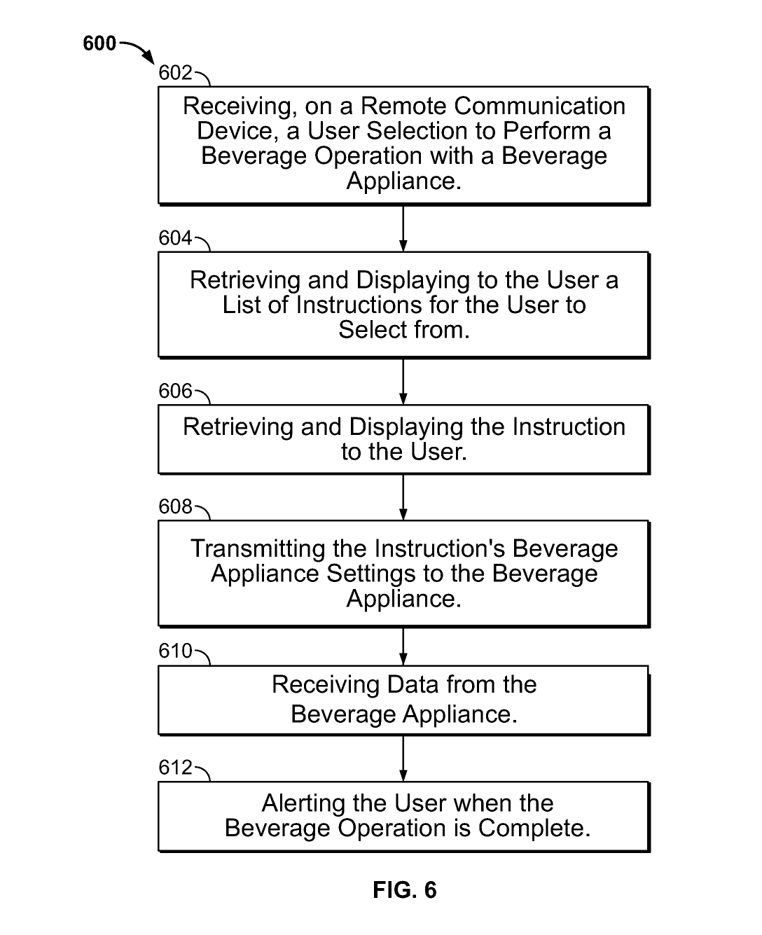

FIG. 6 is a flow diagram of a method 600 for using a beverage appliance to perform a beverage operation (e.g., a beverage making operation such as brewing a pot of coffee, heat water to a desired temperature for further use, etc.) The method 600 includes receiving 602, on remote communication device 104, a user selection to perform a beverage operation with the beverage appliance 102. The remote communication device 104 retrieves and displays to the user, at 604, a list of instructions for the user to select from. At 606, when the user selects an instruction, the remote communication device 104 retrieves and displays the instruction to the user. At 608, the remote communication device 104 transmits to the beverage appliance 102 the settings for the beverage appliance 102 for the selected beverage operation. The beverage appliance 102 settings are set by the beverage appliance 102 as instructed by the remote communication device 104. The settings include the temperature to which the beverage appliance 102 is to be set. Depending on the recipe and/or beverage, the instructions may include a sequence of temperatures and a time for each temperature. The instructions transmitted to the beverage appliance 102 can instruct the beverage appliance 102 to follow a sequence of settings automatically. Moreover, the user may adjust the settings to be different than those included in the retrieved instructions and/or may select from options provided in the instructions.

At 610, the remote communication device 104 receives data from the beverage appliance 102. In this embodiment, the remote communication device 104 receives operational data, such as the status of the beverage appliance 102 (e.g., off/on, power setting, temperature setting, brewing status, etc.) and temperature data about the beverage appliance 102. The remote communication device 104 may also receive beverage data from the beverage appliance 102. Thus, the remote communication device 104 is informed of the temperature of the beverage appliance 102 and can determine when the beverage appliance 102 is heated to the correct temperature for preparing the selected beverage/recipe. In some embodiments, the beverage appliance 102 determines when it has reached the desired temperature and alerts the user through its output device 214 and/or by sending an alert to the remote communication device 104. Alternatively, or additionally, the remote communication device 104 may determine, based on the received temperature data, when the beverage appliance 102 is heated to the desired temperature. Upon determining, either directly or from an alert received from the beverage appliance 102, that the desired temperature has been reached, the remote communication device 104 alerts the user that the beverage appliance 102 is ready for use with a visual and/or audible alert on the remote communication device 104. In some other embodiments, such as when the beverage appliance is an automatic, drip coffee maker, the user need not be informed that water is heated to the proper temperature before the beverage appliance 102 begins brewing the coffee.

At operation 612, the remote communication device 104 alerts the user when the beverage operation is complete and the beverage appliance 102 is ready for further optional action by the user. Thus, the remote communication device informs the user that a beverage is ready to drink and/or when the water in the beverage appliance 102 has reached the set temperature. Thus, the remote communication device 104 will alert that user when an automatic coffee maker has completed brewing a pot of coffee, and when a tea kettle or a single serving coffee maker is at the proper temperature to brew the selected type of tea or coffee. Moreover, after the user adds the water to the tea leaves (or vice versa), the remote communication device 104 will track the appropriate amount of time that the beverage should steep and will alert the user when the steeping time has elapsed. The steeping time is set automatically based on the selected instruction. The user may adjust the steeping time to be different than the time included in the retrieved instructions and/or may select from options provided in the instructions.

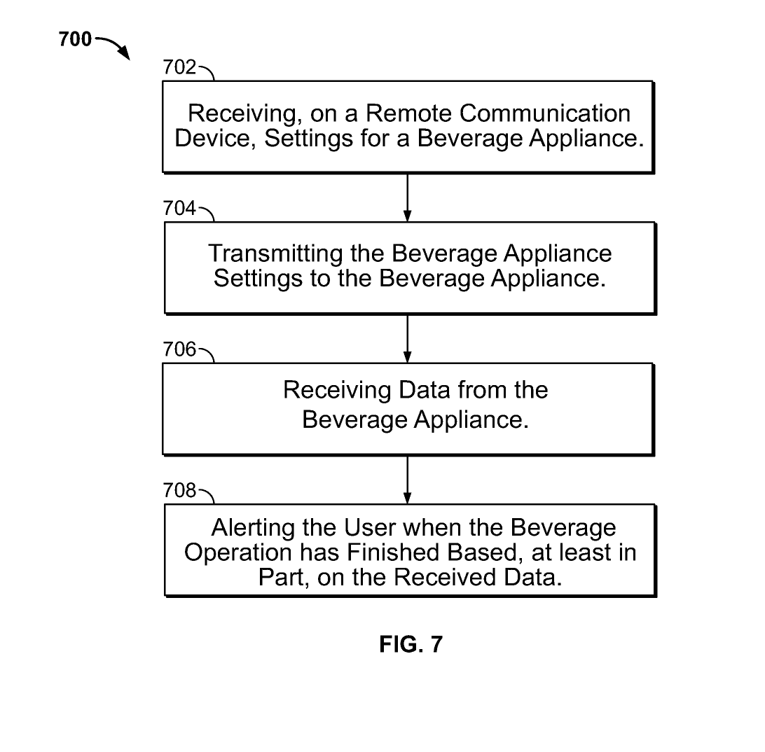

FIG. 7 is a flow diagram of a method 700 for using a beverage appliance. The method 700 includes receiving 702, on the remote communication device 104, settings for the beverage appliance 102. The settings may be manually selected by the user and/or may be derived from an instruction/recipe as described above with respect to the methods 500 and 600. The settings typically include a temperature at which the beverage appliance 102 should operate and a value that will indicate that a brewing operation (e.g., brewing coffee, heating water to a specified temperature, etc.) is complete. For an automatic coffee maker, the value that indicates the brewing is complete is an indication received from the coffee maker that the brewing cycle is completed. Alternatively, the remote communication device 104 may receive sensor data from the coffee maker (e.g., a signal from a weight sensor that detects the weight of fluid in a reservoir or a weight of brewed coffee in a coffee pot) that permits the remote communication device 104 to determine when the brewing is complete. For an electric tea kettle, the temperature of the water in the kettle indicates to the remote communication device 104 when the kettle's operation is complete. In other embodiments, different values may be used to determine completion of brewing.

At 704, the settings for the beverage appliance 102 are transmitted by the remote communication device 104 to the beverage appliance 102. Thus, in the example embodiment, the brewing temperature for the coffee maker beverage appliance 102 is transmitted to the beverage appliance 102 and it operates according to the brewing temperature setting. In some embodiments, the settings also tell the beverage appliance 102 what data to send to the remote communication device 104. Thus, the beverage appliance 102 does not send and the remote communication device 104 does not receive unnecessary and/or unwanted data.

The remote communication device 104 receives, at 706, the beverage data from the beverage appliance 102 and alerts the user, at 708, when the beverage is prepared based, at least in part, on the received beverage data. For example, the remote communication device 104 receives an indication that a certain amount of fluid has exited the fluid reservoir and a specific amount of fluid and/or weight of a beverage is located within a coffee pot and compares the received data to the weight of a beverage that would indicate the beverage is prepared as desired. The desired weight may be automatically set by the remote communication device 104 based on the type of beverage, may be manually set by the user, and/or may be selected by the user from options (such as between dark roast, medium roast, light roast, etc.). In some instances, the desired weight may be set by the remote communication device 104 and the user may not be permitted to change the desired weight. Alternatively, the user may be permitted to change the desired weight or brew type only after acknowledging a warning about deviating from the recommended weight.

The methods 500, 600, and 700 described above are neither the only methods that may be performed using the system 100, nor are they exclusive from each other. The features of the methods 500, 600, and 700 may combined in various permutations and combinations for use with the system 100.

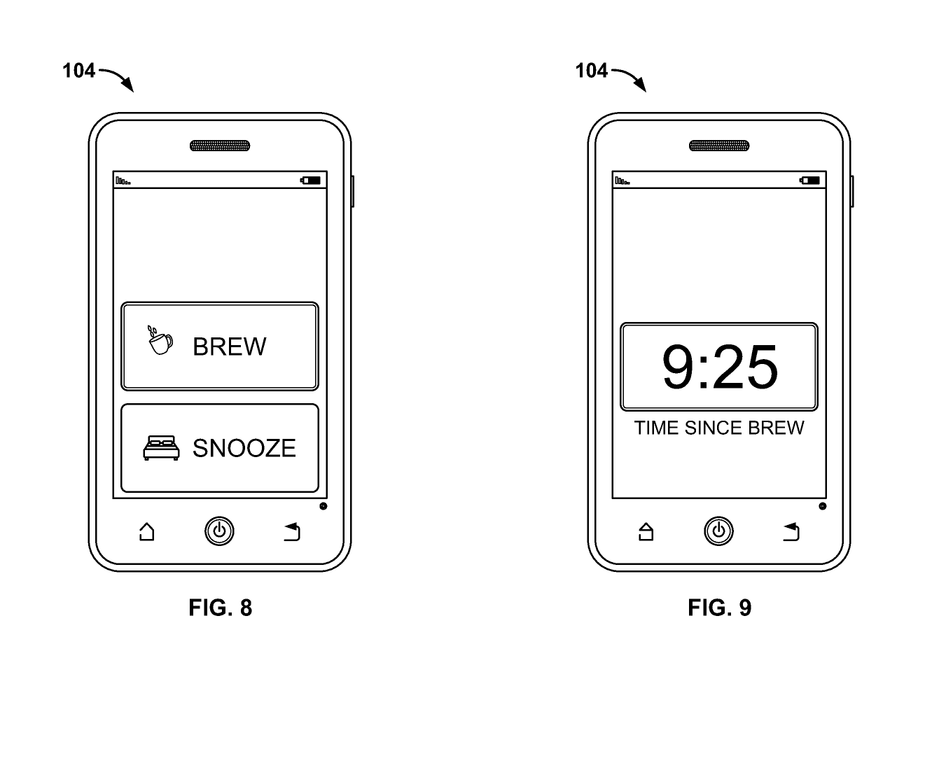

FIGS. 8 and 9 illustrate displays on the remote communication device 104 when used in conjunction with the beverage appliance 102.

FIG. 8 shows a display on the remote communication device 104 where a user may select between instructing the beverage appliance 102 to brew a beverage immediately or to wait a specific amount of time before brewing the beverage. It is contemplated that additional options may be presented to the user, such as options to turn the beverage appliance 102 on/off, set the temperature of the beverage appliance 102, and view recipes for use with the beverage appliance 102. In other embodiments, the menu may include more or fewer options. For example, in some embodiments, the menu includes a statistical data option to view statistical data about the beverage appliance 102 (hours of use, serial number, etc.), a help option to access help files and instructions for operating the beverage appliance 102, a monitor option to monitor the settings, beverage data, and/or operational data without controlling the beverage appliance 102, and/or a maintenance option to view recommended/required maintenance procedures.

In FIG. 9, the remote communication device 104 is displaying an amount of time since the brewing of a beverage. In some embodiments, the user may select to receive an alarm when a selected amount of time has elapsed after brewing and/or to automatically shut off the beverage appliance when the selected amount of time has elapsed.

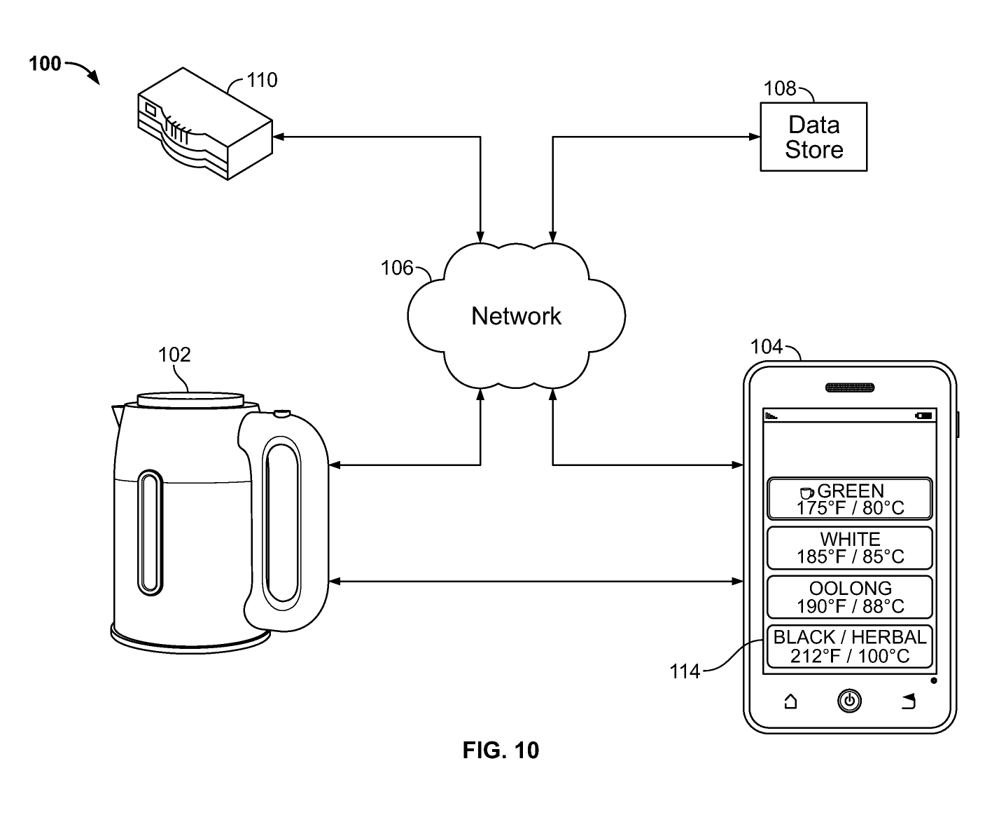

FIG. 10 is an embodiment of the system 100 including a beverage appliance 102, which is an electric tea kettle. A list of types of tea the user may brew is presented on the remote communication device 104 to the user. The user selects the desired type of tea, which is associated with a specific temperature at which to brew the tea and a specific amount of steep time. For instance, a user may select a green tea option through the remote communication device 104. Based on the user's selection of green tea, the tea kettle will heat water to 175 degree Fahrenheit and instruct the user to steep the tea in the 175 degree Fahrenheit water for three minutes. Additionally, once the tea is done steeping, an indication that the tea is done steeping is sent to the remote communication device 104 and an alert is presented to the user that the tea is ready.

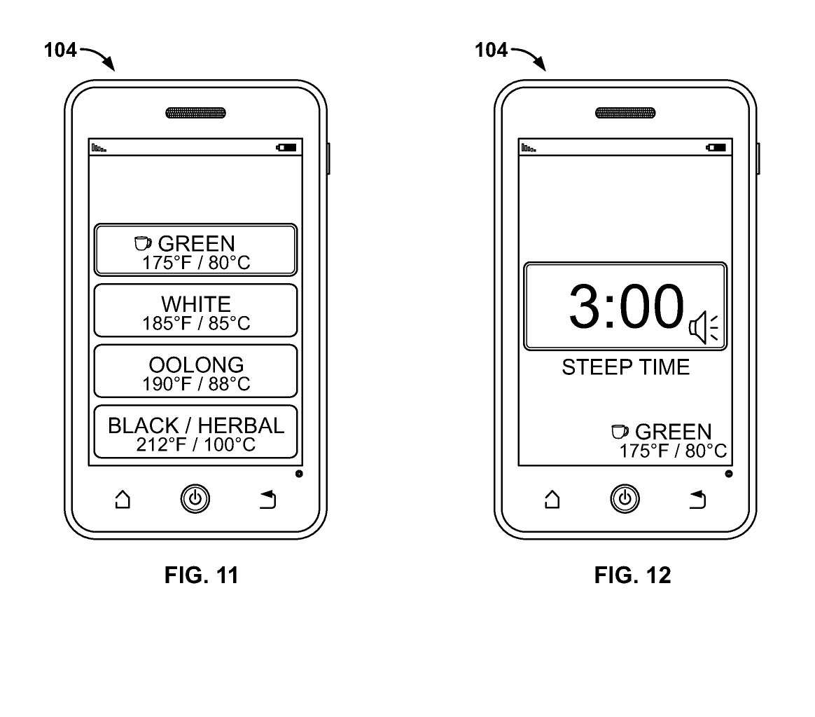

FIGS. 11 and 12 illustrate displays on the remote communication device 104 when used in conjunction with another embodiment of the beverage appliance 102. In FIG. 11, the remote communication device 104 includes a display for selecting a specific recipe (i.e., type of tea). The recipe is associated with instructions to present to a user and/or operations to control the beverage appliance 102 as described above. For instance, a selection of green tea may have a steep time of 3:00 minutes, as shown in FIG. 12. The display shown in FIG. 12 counts down the remaining steeping time and sounds an alarm when the steeping time has elapsed. It is contemplated that additional options may be presented to the user, such as options to turn the beverage appliance 102 on/off, set the temperature of the beverage appliance 102, and view recipes for use with the beverage appliance 102. In other embodiments, the menu may include more or fewer options. For example, in some embodiments, the menu includes a statistical data option to view statistical data about the beverage appliance 102 (hours of use, serial number, etc.), a help option to access help files and instructions for operating the beverage appliance 102, a monitor option to monitor the settings, beverage data, and/or operational data without controlling the beverage appliance 102, and/or a maintenance option to view recommended/required maintenance procedures.

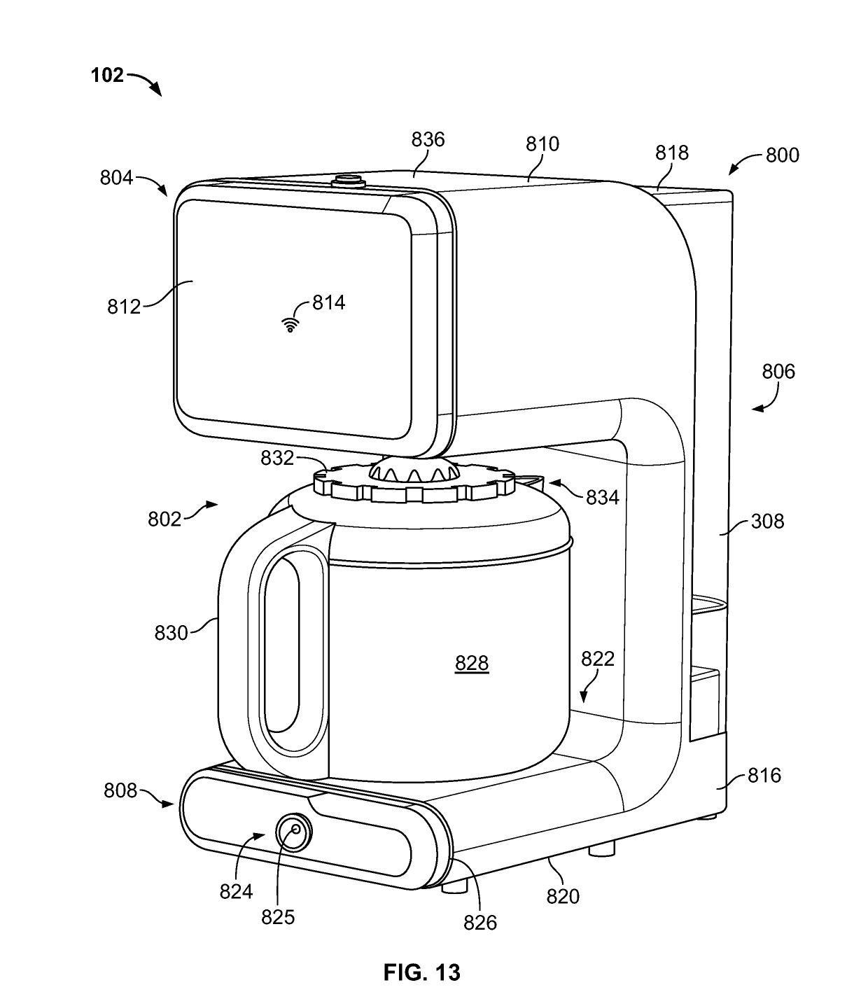

FIG. 13 illustrates an example beverage appliance 102. In this embodiment, the beverage appliance 102 includes a base 800 and a carafe 802. The base 800 includes an upper portion 804, a rear portion 806, and a lower portion 808.

The upper portion 804 includes a shell 810, including a front panel 812, a movable cover 836, and an indicator 814. In some embodiments, the shell 810 forms an enclosed region that is accessible via the movable cover 836. The enclosed region may contain various components (which are not shown) that operate to make beverages, such as heating elements, fluid transport and dispensing devices, basket devices (e.g., to hold filters, coffee grounds, etc.), sensors, and other devices. The movable cover 836 operates to actuate between positions so as to permit access to the enclosed region within the shell 810 (e.g., so that a user of the beverage appliance 102 may insert/remove filters or coffee grounds, clean or perform other maintenance on the beverage appliance 102, etc.). In some embodiments, the movable cover 836 is coupled to the shell 810 with at least one hinge. In at least some embodiments, the movable cover 836 is secured in a closed position with a securing device such as a latch. Alternatively or additionally, the movable cover 836 may be biased to a closed position with a spring. In at least some embodiments, a button, lever, or another type of actuatable control is included that operates to release the securing device.

Additionally, in some embodiments, the shell 810 contains one or more of the computing device 200, the controller 302, the communication receiving component 402, the communication determining component 404, and the communication transmitting component 406. As noted previously, in some embodiments, the computing device 200 and the controller 302 are the same device. Additionally, as also noted previously, the controller 302 may include one or more of the communication receiving component 402, the communication determining component 404, and the communication transmitting component 406. In some embodiments, one or both of the communication receiving component 402 and the communication transmitting component 406 are disposed near the front panel 812 so as to, for example, optimize communication by minimize interference to communication signals caused by the various components of the beverage appliance 102. Additionally or alternatively, one or more of the computing device 200, the controller 302, the communication receiving component 402, the communication determining component 404, and the communication transmitting component 406 are disposed elsewhere in the beverage appliance 102 such as the rear portion 806 or the lower portion 808.

The indicator 814 operates to convey information about a status of the beverage appliance 102. In some embodiments, the indicator 814 includes one or more light-emitting device such as light-emitting diodes (LEDs). Additionally, in some embodiments, the indicator 814 includes a display panel such as an LED panel or a liquid-crystal-display (LCD) panel. In some embodiments, the indicator 814 operates to convey a status related to one or more of whether the beverage appliance 102 has power, is on, is connected to the network 106, is connected to the remote communication device 104, is transmitting information, or is receiving information. In some embodiments, the indicator 814 may emit light in one color to indicate a particular status (e.g., yellow light may indicate that the beverage appliance 102 is powered on, blue light may indicate that a connection between the remote communication device 104 and the beverage appliance 102 has been established, etc.). In some embodiments, status information is also conveyed by blinking the indicator. For example, the indicator 814 may blink in a first color to indicate that the beverage appliance 102 is receiving data and in a second color to indicate that the beverage appliance 102 is transmitting data.

In some embodiments, the rear portion 806 includes the fluid reservoir 308 and a reservoir base 816. In other embodiments, the fluid reservoir 308 is disposed elsewhere in the beverage appliance 102 such as in the upper portion 804 or the lower portion 808. Additionally, some embodiments may include multiple fluid reservoirs that operate to store the same or different fluids (e.g., each containing one of water, milk, and cream). The fluid reservoir 308 may include a removable cover 818. The removable cover 818 operates to permit access to the fluid reservoir 308 (e.g., for filling with fluid, cleaning, etc.).

The reservoir base 816 operates to receive and couple to the fluid reservoir 308. In some embodiments, the reservoir base 816 removably couples to the fluid reservoir 308 so that the fluid reservoir 308 may be removed. Additionally, in some embodiments, the reservoir base 816 includes various additional components (which are not shown) such as sensors and fluid transport devices. For example, the reservoir base 816 may include a sensor to detect the weight of the reservoir so that a quantity of liquid within the reservoir may be determined. Additionally, the reservoir base 816 may include one or more fluid transport devices to transport fluid from the fluid reservoir 308 to an appropriate destination such as upper portion 804.

In some embodiments, the lower portion 808 includes a shell 820, a surface 822, an actuatable control 824, and an indicator 826. In some embodiments, the shell 820 forms an enclosed region. The enclosed region may contain various components (which are not shown), such as one or more heating elements, sensors, and other devices. The heating elements may operate to heat the carafe 802 so as to keep a beverage that has been made at a particular temperature. The sensors may operate to sense the temperature of a heating element, the surface 822, the carafe 802, or other components of the beverage appliance 102. Additionally or alternatively, the sensors may operate to detect force upon the surface 822 such as to determine whether the carafe 802 is present. In some embodiments, the sensors operate to detect a weight on the surface 822 such as to determine a property of the carafe 802, such as the materials it is formed from or a quantity of fluid contained within the carafe 802.

The surface 822 operates to support the carafe 802. In some embodiments, the surface 822 may include various surface features such as ridges or indentations that operate to guide the carafe 802 into a proper position for beverage making operations.

The actuatable control 824 operates to receive an input from a user of the beverage appliance 102. In some embodiments, the actuatable control 824 comprises a switch, button, or another type of actuatable control. In some embodiments, the actuatable control 824 operates to control whether the beverage appliance 102 is turned on or off. Alternatively or additionally, the actuatable control may operate to adjust a setting of the beverage appliance 102 such as a temperature at which a beverage is kept. In some embodiments, the actuatable control 824 operates to start or stop a beverage making operation. The actuatable control 824 may include an indicator 825 such as a light emitting device that indicates a status of the beverage appliance such as whether the beverage appliance 102 is turned on. Some embodiments include multiple of the actuatable control 824, while other embodiments do not include an actuatable control 824.

Beneficially, in some embodiments, only a simple interface is included because the beverage appliance can be controlled using the remote communication device. For example, some embodiments do not include any controls for operating the beverage making appliance (i.e., the beverage appliance is solely controllable through the remote communication device). While other embodiments, may include only a single control such as a button to turn the beverage appliance on or off. Yet other embodiments include a second button that operates to start a beverage making operation (e.g., brew a pot of coffee). In these example embodiments, more complicated operations (e.g., scheduling a beverage making operation) are performed using the remote communication device allowing the interface on the beverage appliance itself to remain simple (and correspondingly less expensive).

The indicator 826 operates to convey information about a status of the beverage appliance 102. In some embodiments, the indicator 826 is similar to either the indicator 814 or the indicator 825 (which have both been described above). Additionally or alternatively, the indicator 826 comprises a light pipe formed from LEDs or fiber optic cables. In some embodiments, the indicator 826 emits light to indicate that the beverage appliance 102 is turned on.

The carafe 802 operates to receive and contain beverages that are made by the beverage appliance 102. In some embodiments, the carafe 802 includes a container 828, a handle 830, a cover 832, and a spout 834.

The container 828 includes a region for containing a quantity of fluid. In various embodiments, the container 828 is formed from various materials. For example, in some embodiments the container 828 is formed from one or more of tempered glass or another material having thermal or insulating properties (such as stainless steel). Additionally, in some embodiments, the container is formed from multiple layers of material and may contain an insulating element (such as one or more pockets containing a vacuum, air, or another insulating materials between layers of material).

The handle 830 is a device that is configured to be held in the hand of a user of the beverage appliance 102. The handle 830 may be formed from the same material as the container 828 or a different material. In some embodiments, the handle 830 may be formed from one or more plastic or metal materials.

The cover 832 operates to cover the container 828. In at least some embodiments, the cover 832 is removable or partially removable (e.g. the cover 832 is movably coupled to the container 828 such as with a hinge). In some embodiments, the cover 832 operates to permit access to the interior of the container 828 such as to access a beverage or for cleaning.

The spout 834 operates to facilitate pouring a beverage out from the container 828. In some embodiments, the spout 834 is a groove formed in an upper edge of the container 828.

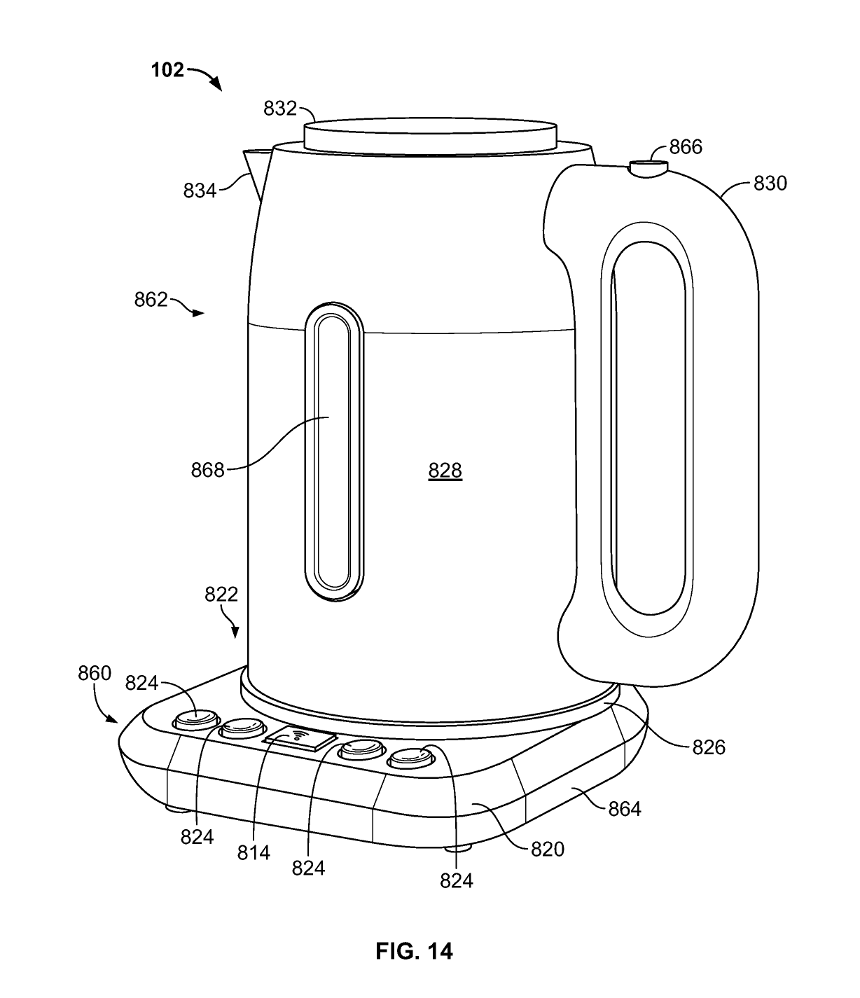

FIG. 14 illustrates another example beverage appliance of FIG. 1. In this embodiment, the beverage appliance 102 includes a base 860 and a kettle 862. The base 860 includes a lower portion 864. The lower portion 864 may be similar to the lower portion 808 (described previously at least with respect to FIG. 13).

In some embodiments, the lower portion 864 includes the indicator 814, the shell 820, the surface 822, four of the actuatable control 824, and the indicator 826 (which have all been described previously at least with respect to FIG. 13). In some embodiments, each of the four of the actuatable control 824 operate to set a different temperature for a heating element contained in the shell 820 and used to heat the kettle 862.

The kettle 862 operates to receive and contain fluids, such as water, that may be used to make various beverages, such as tea. In some embodiments, the kettle may be similar to the carafe 802 (previously illustrate and described at least with respect to FIG. 13). In some embodiments, the kettle 862 includes the container 828, the handle 830, the cover 832, the spout 834, an actuatable control 866, and a window 868. However, some embodiments do not include one or both of the actuatable control 866 and the window 868. Each of the container 828, the handle 830, the cover 832, and the spout 834 have been previously described at least with respect the carafe 802 illustrated in FIG. 13.

The actuatable control 866 may be similar to the actuatable control 824. In some embodiments the actuatable control 866 operates to actuate the cover 832 into an open position such as to allow a fluid to be poured into the container 828.

The window 868 operates to permit viewing of the contents of the container 828. In some embodiments the window 868 is formed from a translucent or transparent material such as tempered glass. Beneficially, the window 868 allows a user of the beverage appliance 102 to evaluate the quantity of fluid in the container 828 and the state of the fluid (e.g., whether the fluid is boiling).

FIG. 15 is a flowchart illustrating an example method 900 of operating the remote communication device network configuration component 418. In some embodiments, the method 900 includes operations 902, 904, 906, 908, 910, 912, 914, 916, and 918. The method 900 includes operations that are performed by one or more processors, such as the processor 204 as illustrated in FIG. 2. In other embodiments, the method 900 includes only some of the operations or one or more additional operations. The operations can be performed in different orders in other embodiments.

In some embodiments, the method 900 is performed when a wireless connection is initially set up between the beverage appliance 102 and the remote communication device 104 via the network 106. Once a wireless connection has been initially established via the router 110, the remote communication device 104 can be connected to the beverage appliance 102 via the router 110 without performing the method 900.

At the operation 902, the remote communication device network configuration component 418 of the remote communication device 104 receives a service set identifier (SSID) of the beverage appliance 102. The SSID may be entered by a user of the remote communication device 104. Alternatively, the SSID may be broadcast or otherwise transmitted to the remote communication device 104 by the beverage appliance 102. Although the method 900 is described in terms of establishing a connection between the beverage appliance 102 and the remote communication device 104 using an SSID (e.g., for wireless communication using WiFi protocols), other embodiments use other or additional communication protocols such as BlueTooth® or ZigBee®. In those embodiments, an appropriate identifier for the communication protocol of the beverage appliance 102 is received by the remote communication device 104.

At the operation 904, the remote communication device network configuration component 418 displays information about the beverage appliance 102 on the remote communication device 104. The information about the beverage appliance 102 is determined based upon the SSID received from the beverage appliance 102.

At the operation 906, the remote communication device network configuration component 418 receives a user selection of the beverage appliance 102. Where there are multiple beverage appliances 102 detected by the remote communication device 104, a list of available beverage appliances 102 is displayed on the remote communication device 104 at the operation 604. A user can select one of the displayed beverage appliances 102 through the remote communication device 104.

At the operation 908, the remote communication device network configuration component 418 prompts the user to enter identification information about the selected beverage appliance 102. In some embodiments, the remote communication device network configuration component 418 displays a screen asking for specific information identifying the selected beverage appliance 102. For example, the user can type in relevant identification information through the remote communication device 104 as required. The identification information is information unique to the selected beverage appliance 102, such as a serial number. In some embodiments, the identification information is provided with the beverage appliance 102, and the user can find the information and enter the information through the remote communication device 104. The operation 908 can ensure a secure connection between the beverage appliance 102 and the remote communication device 104.

At the operation 910, the remote communication device network configuration component 418 operates to wirelessly connect to the beverage appliance 102 based upon the SSID received at the operation 902 and the identification information received at the operation 908.

At the operation 912, the remote communication device network configuration component 418 displays a list of wireless connections available between the beverage appliance 102 and the remote communication device 104.

At the operation 914, the remote communication device network configuration component 418 receives a user selection of one of the available wireless connections. For example, the user can select to the network 106 via the router 110.

At the operation 916, the remote communication device network configuration component 418 prompts the user to enter a connection password that has been set up in the router 110.

At the operation 918, the remote communication device network configuration component 418 sends an SSID of the remote communication device 104 and the wireless connection password to the beverage appliance 102 to allow the beverage appliance 102 to set up network access to the network 106 via the router 110. Once the network access has been set up with the router 110, the beverage appliance 102 and the remote communication device 104 can communicate via the network 106.

In some embodiments, the beverage appliance 102 is configured to remain on even if the beverage appliance 102 and the remote communication device 104 lose its connectivity. In other embodiments, the beverage appliance 102 is configured to automatically turned off when a network connection is lost between the beverage appliance 102 and the remote communication device 104.

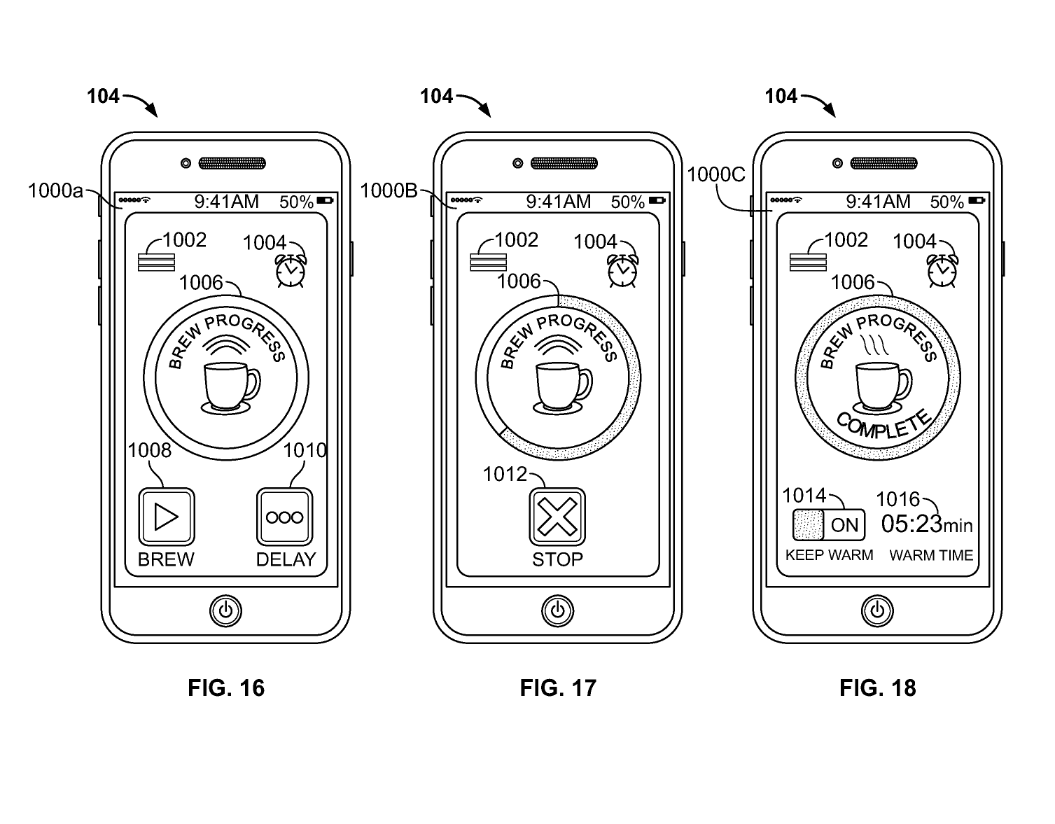

FIG. 16 illustrates an example home screen 1000a displayed on the output device 214 of some embodiments of the remote communication device 104. In some embodiments, the home screen 1000a is displayed when the beverage appliance 102 is not performing and has not recently performed a beverage making operation. The home screen 1000a includes a menu button 1002, a status indicator 1004, a progress indicator 1006, a start button 1008, and a delay button 1010.

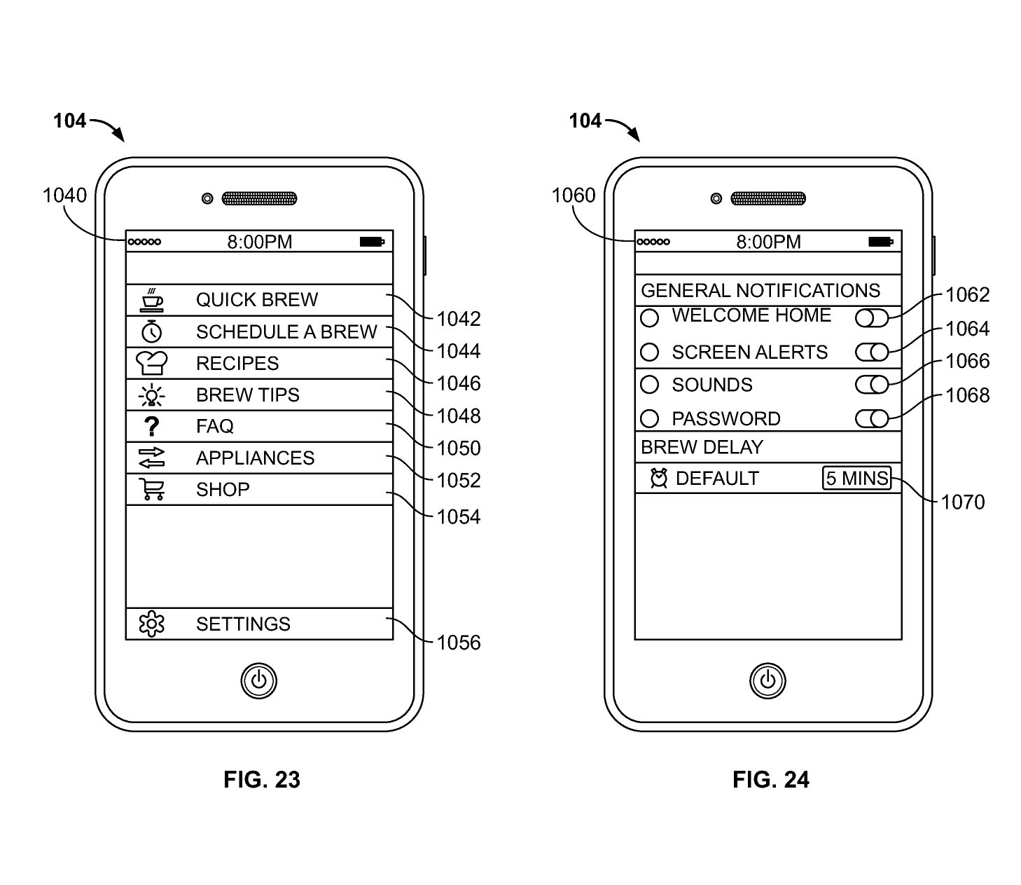

The menu button 1002 operates to display a menu that permits a user to perform various operations with the remote communication device 104. Upon actuation of the menu button 1002, the remote communication device 104 may display a menu of various operations. An example menu is illustrated and described with respect to FIG. 23.

The status indicator 1004 operates to display the current status of the system 100. In some embodiments, different images are displayed for the status indicator 1004 based on a status of the system 100. For example, different images may be displayed for the status indicator 1004 to indicate a default state, a scheduled state, a delayed (or snooze) state, and a canceled state. The default state may indicate that the remote communication device 104 does not have any beverage making operations scheduled and activated for the beverage appliance 102. The scheduled state may indicate the remote communication device 104 has an upcoming beverage making operation scheduled for the beverage appliance 102. The delayed state may indicate that a scheduled beverage making operation has been delayed for a defined time period (e.g., via input received at the delay button 1010). The canceled state may indicate that a scheduled beverage making operation has been canceled. The status indicator 1004 included in the example home screen 1000a may indicate that the system 100 is in a scheduled state.

The progress indicator 1006 operates to indicate the status of a beverage making operation. In some embodiments, a portion of the progress indicator 1006 changes colors as the beverage making operation completes. In some examples, a graphical ring displayed in the progress indicator 1006 transforms from a first visual property (e.g., lighter, gray, etc.) to a second visual property (e.g., darker, blue, etc.) in a clockwise manner as the beverage making operations progresses (this transformation is illustrated by comparing the illustrations of the progress indicator 1006 in FIGS. 16-18). In other embodiments, the progress indicator 1006 uses other indicators (such as graphical, textual, or numerical indicators) to indicate progress of the beverage making operation (e.g., a percentage, a narrative of the steps being performed, a circle filling, a line/bar growing or shrinking, etc.).

The start button 1008 operates to start a beverage making operation. For example, in some embodiments, the start button 1008 causes the remote communication device 104 to transmit a command to the beverage appliance 102 to start brewing coffee.

The delay button 1010 operates to delay a scheduled beverage making operation. Upon actuation of the delay button 1010, in some embodiments, the schedule brew is delayed for by a predetermined time period (e.g., five minutes to an hour). Additionally, in some embodiments, upon actuation of the delay button 1010 the remote communication device 104 display a delay option menu through which a user may select a length of time for the delay. In some embodiments, the delay option menu pre-selects a default delay time period but allows a user to select a different time period to override the default time period.

FIG. 17 illustrates an example home screen 1000b displayed on the output device 214 of some embodiments of the remote communication device 104. In some embodiments, the home screen 1000b is displayed when the beverage appliance 102 is performing a beverage making operation. The home screen 1000b includes the menu button 1002, the status indicator 1004, the progress indicator 1006, and a cancel button 1012. In the example home screen 1000b, the progress indicator 1006 is shown as partially filled (i.e., a visual property of a portion of the ring has been modified (e.g., changed from lighter to darker, from blue to gray, etc.)) because the beverage making operation is partially complete.

The cancel button 1012 operates to cancel a beverage making operation that is imminent or currently in progress on the beverage appliance 102. In some embodiments, upon actuation of the cancel button 1012, the remote communication device 104 transmits a command to the beverage appliance 102 to immediately stop a beverage making operation.

FIG. 18 illustrates an example home screen 1000c displayed on the output device 214 of some embodiments of the remote communication device 104. In some embodiments, the home screen 1000c is displayed when the beverage appliance 102 has completed a beverage making operation. The home screen 1000c includes the menu button 1002, the status indicator 1004, the progress indicator 1006, a keep warm slider 1014, and a keep warm indicator 1016. In the example home screen 1000c, the progress indicator 1006 is shown as being completely filled (i.e., a visual property of the entire has been modified (e.g., changed from lighter to darker, from gray to blue, etc.)) because the beverage making operation is complete.

The keep warm slider 1014 operates to display and control whether the beverage appliance 102 is currently operating to keep a completed beverage warm. Using the keep warm slider 1014, a user can toggle whether the beverage is being kept warm. In some embodiments, upon actuation of the keep warm slider 1014, the remote communication device 104 transmits a command to the beverage appliance to activate or deactivate a heating element that is configured to warm a completed beverage.

The keep warm indicator 1016 operates to display an indication of how long a beverage has been kept warm. In some embodiments, the time the beverage has been kept warm corresponds to the time since the beverage making operation completed. Accordingly, the keep warm indicator 1016 may provide an indication of the freshness of the beverage. In the embodiment shown in FIG. 18, the keep warm indicator 1016 shows the keep warm time numerically as a number of minutes and a number of seconds. Other embodiments are possible that include various other graphical, textual, or numerical indicators (such as freshness meter, a textual description of the estimated freshness of the beverage, etc.). Additionally, in at least some embodiments, the color or intensity of the indicator 814 or the indicator 826 based on keep warm time. For example, the remote communication device 104 may transmit instructions to the beverage appliance 104 to adjust the lights based on the keep warm time (e.g., to a first color to indicate the beverage has been kept warm for a shorter time and to a second color to indicate that the beverage has been kept warm for a longer time).

Some embodiments do not include one or both of the keep warm slider 1014 or the keep warm indicator 1016. For example, some embodiments in which the container 828 is formed from a thermal (insulated) material do not include the keep warm slider 1014 as heating elements contained with the base 800 will not be effective at transmitting heat through the thermal (insulated) material to the beverage contained therein. Additionally, in some of these embodiments, the keep warm indicator 1016 may simply indicate how much time has passed since the beverage making operation completed.

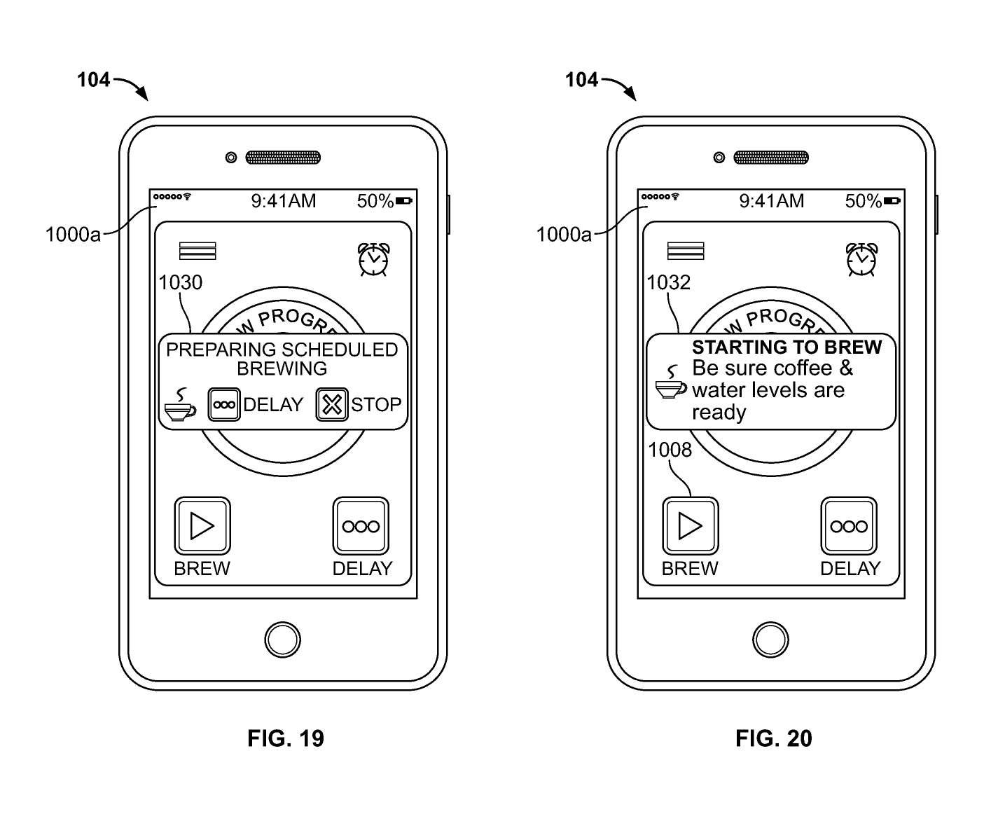

FIG. 19 is another illustration of the example home screen 1000a displaying a notification message 1030. In some embodiments, the notification message 1030 is displayed for a defined time period prior to a scheduled beverage making operation. In some examples, the notification message 1030 is first displayed 30 seconds before the remote communication device 104 transmits a command to the beverage appliance 102 to start the beverage making operation. In other embodiments, the notification message 1030 is first displayed between 30 and 300 seconds prior to commencement of the scheduled beverage making operation. Beneficially, by displaying the notification message 1030, a user of the remote communication device 104 has an opportunity to cancel or delay the beverage making operation as desired. In some embodiments, the notification message 1030 includes different textual and graphical elements than those illustrated in FIG. 19.

FIG. 20 is another illustration of the example home screen 1000a displaying a notification message 1032. In some embodiments, the notification message 1032 is displayed for a defined time period after the start button 1008 is actuated. In some examples, the notification message 1032 is displayed for 30 seconds before the remote communication device 104 transmits a command to the beverage appliance 102 to start the beverage making operation. In other embodiments, the notification message 1032 is displayed for between 15 and 60 seconds prior to transmitting the command to start the beverage making operation to the beverage appliance 102. Beneficially, by displaying the notification message 1032, a user of the remote communication device 104 may cancel an inadvertent actuation of the start button 1008. Additionally, by displaying the notification message 1032, the user has an opportunity to verify that the beverage appliance 102 is configured to perform the brewing operation. In some embodiments, the notification message 1032 includes different textual and graphical elements than those illustrated in FIG. 20.

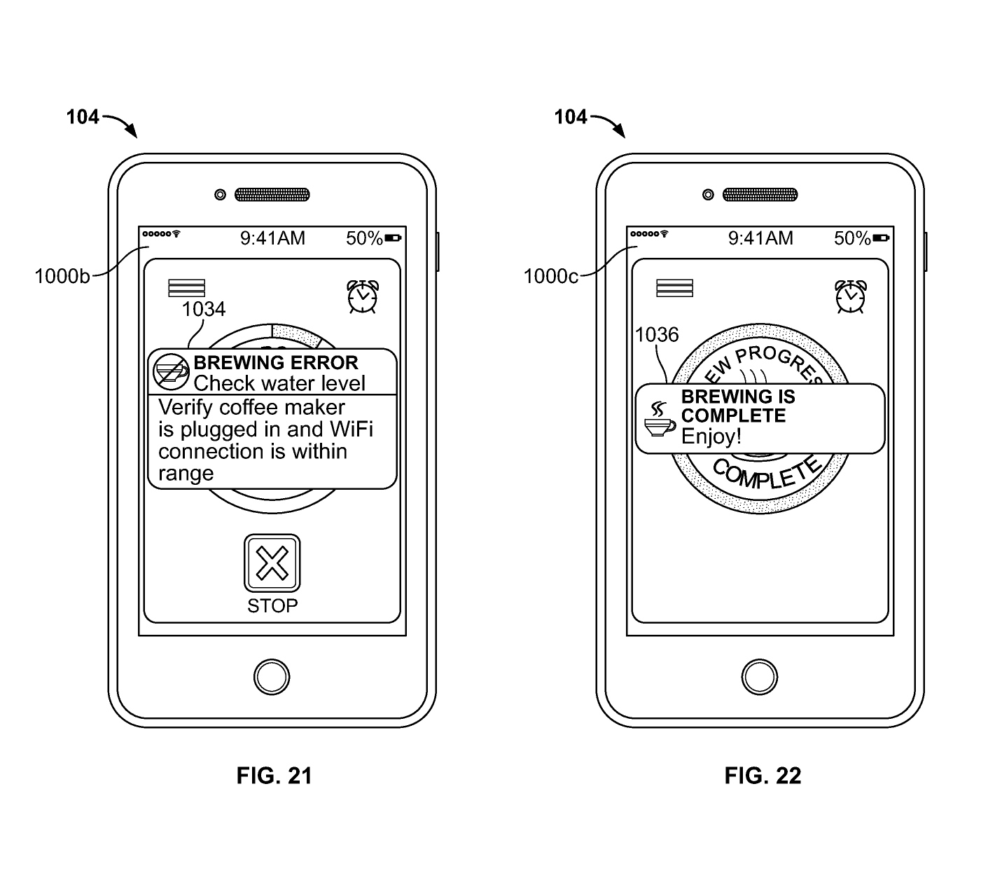

FIG. 21 is another illustration of the example home screen 1000b displaying a notification message 1034. In some embodiments, the notification message 1034 is displayed when an error occurs during a beverage making operation on the beverage appliance 102. Beneficially, by displaying the notification message 1034, a user of the remote communication device 104 is alerted to an error with the beverage making operation and can take steps to immediately remedy the error. In some embodiments, the notification message 1034 includes different textual and graphical elements than those illustrated in FIG. 21.

FIG. 22 is another illustration of the example home screen 1000c displaying a notification message 1036. In some embodiments, the notification message 1036 is displayed when a beverage making operation has completed on the beverage appliance 102. Beneficially, by displaying the notification message 1036, a user of the remote communication device 104 is alerted that the beverage is available even if the user is not in immediate proximity of the beverage appliance 102. In some embodiments, the notification message 1034 includes different textual and graphical elements than those illustrated in FIG. 22.

Although the notification messages 1030, 1032, 1034, 1036 are illustrated as being displayed on the various home screens 1000a, 1000b, 1000c, in some embodiments the notification messages 1030, 1032, 1034, 1036 are additionally or alternatively displayed elsewhere. Further, some embodiments do not include all of the notification messages 1030, 1032, 1034, 1036 and may include additional and different notification messages as well. Additionally, in some embodiments, some or all of the notification messages 1030, 1032, 1034, 1036 as well as other notification messages are displayed outside of the application 114 (such as in a toolbar or interface element of the remote communication device 104).

FIG. 23 illustrates an example menu screen 1040 displayed on the output device 214 of some embodiments of the remote communication device 104. In some embodiments, the menu screen 1040 is displayed when the menu button 1002 is actuated on one of the home screens 1000a, 1000b, 1000c (which are illustrated and described at least with respect to FIGS. 16-18). In some embodiments, the menu screen 1040 includes a quick make beverage menu option 1042, a schedule beverage menu option 1044, a recipes menu option 1046, a tips menu option 1048, a Frequently Asked Questions (FAQ) menu option 1050, an appliances menu option 1052, and a shop menu option 1054. Also included on embodiments of the menu screen 1040 is a settings button 1056. In some embodiments, the menu screen 1040 includes different, additional, or fewer menu options or buttons.

In some embodiments, upon actuation, the quick make beverage menu option 1042 operates to return to the home screen 1000a where the user may use the start button 1008 to start a beverage making operation on the beverage appliance 102. In other embodiments, the quick make beverage menu option 1042 operates to immediately send a command to the beverage appliance 102 to begin a beverage making operation.

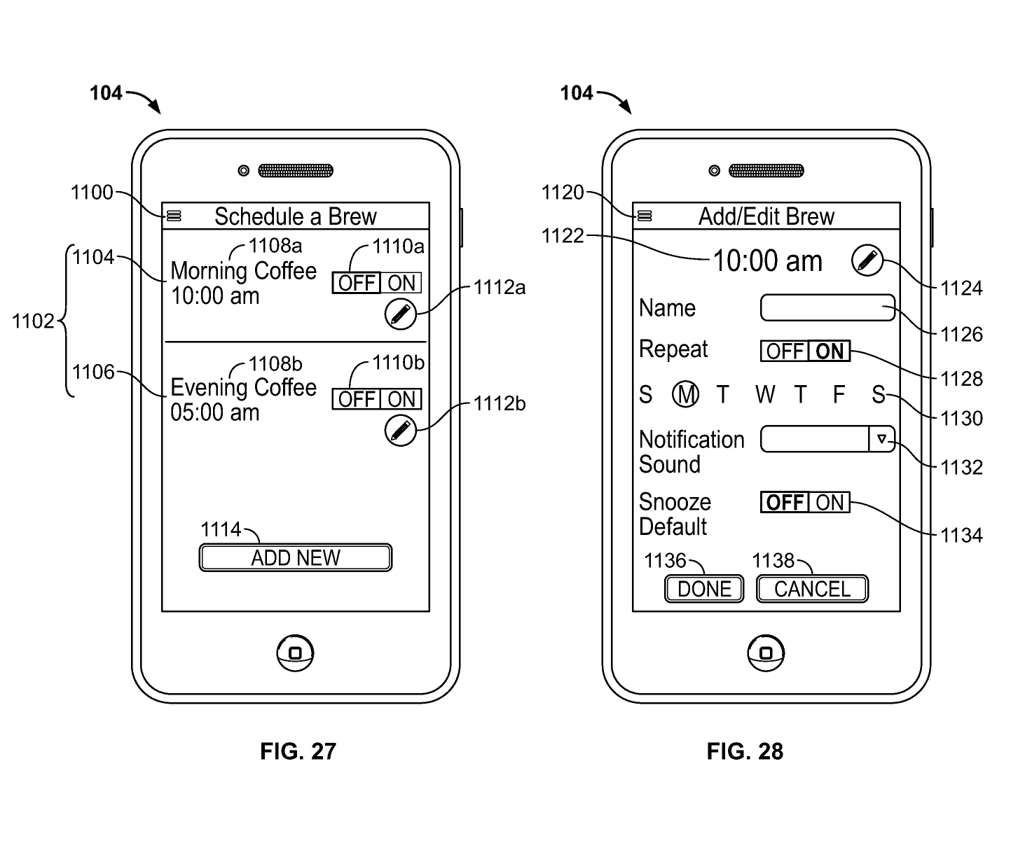

The schedule beverage menu option 1044 operates to display screens for reviewing and configuring scheduled beverage making operations (which are illustrated and described at least in FIGS. 27 and 28).

The recipes menu option 1046 operates to display a list of beverage making recipes. Various methods of displaying and using beverage making recipes are illustrated and describes at least with respect to FIGS. 5 and 6.

The tips menu option 1048 operates to display tips for making beverages using the system 100. In some embodiments, a single tip is displayed. In other embodiments, multiple tips are displayed. In yet other embodiments, a list or outline of tip subjects is displayed and a user may navigate through the list or outline to view particular tips. In some embodiments, the tips are selected based on historical usage data for the beverage appliance 102 (such as data included in the maintenance and error data).

The FAQ menu option 1050 operates to display questions and help information related to the system 100. In some embodiments, upon actuation, the FAQ menu option 1050 displays an interface for searching for help on particular topics. Alternatively or additionally, the FAQ menu option may cause a list or outline of FAQ/help topics to be displayed that a user can navigate.

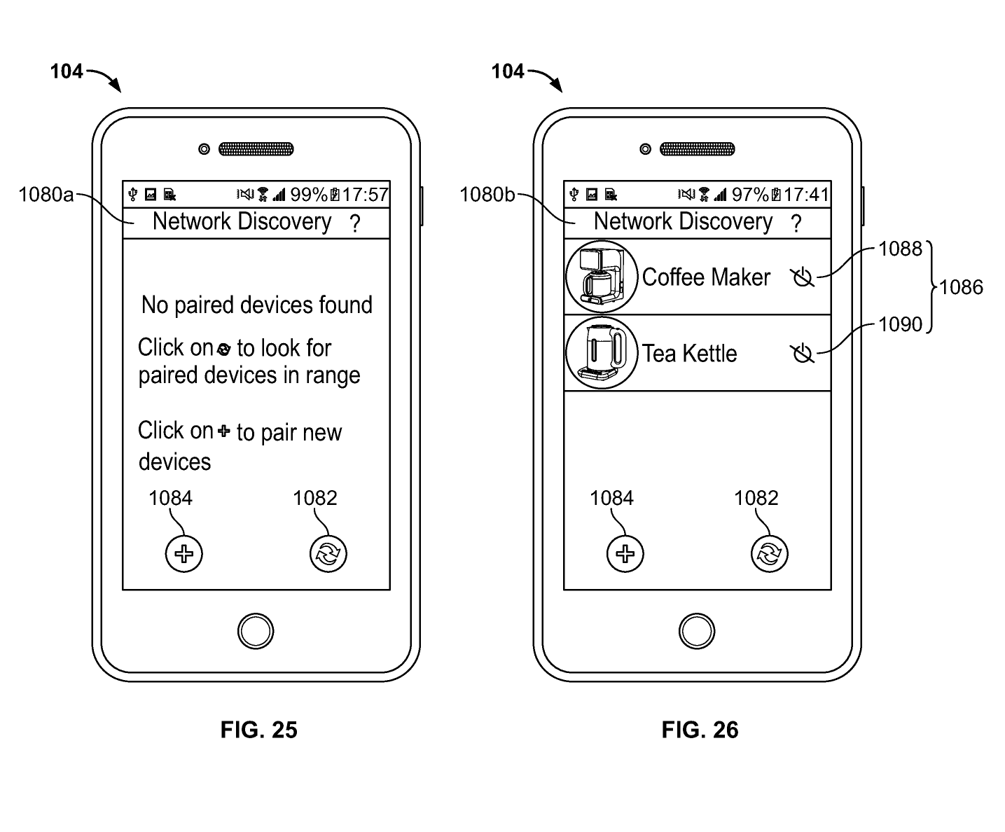

The appliances menu option 1052 operates to display screens for configuring the remote communication device to connect to and control one or more beverage appliances 102. Example display screens displayed upon actuation of the appliances menu option 1052 by some embodiment of the remote communication device 104 are illustrated and described at least with respect to FIGS. 25 and 26.

The shop menu option 1054 operates to display screens for shopping for and purchasing additional appliances, accessories, or consumables for the system 100. Additionally, in some embodiments, the shop menu option 1054 causes a web browser application available on the remote communication device 104 to load a particular web site for shopping. In some embodiments, upon actuation, the shop menu option 1054 selects purchasable products to display based on historical usage data for the beverage appliance 102 (such as data included in the maintenance and error data).

The settings button 1056 operates to display screens through which a user can adjust various settings of the remote communication device 104 that are related to the system 100. Examples of the screens displayed upon actuation of the settings button 1056 are illustrated and described with respect to at least FIG. 24.

FIG. 24 illustrates an example settings screen 1060 displayed on the output device 214 of some embodiments of the remote communication device 104. In some embodiments, the settings screen 1060 is displayed when the settings button 1056 is actuated on the menu screen 1040 (which is illustrated and described at least with respect to FIG. 23). In some embodiments, the settings screen includes a welcome home slider 1062, a screen alerts slider 1064, a sounds slider 1066, a password slider 1068, and a default delay selector 1070. In some embodiments, the settings screen 1060 includes different, additional, or fewer sliders and selectors.

The welcome home slider 1062 indicates the current status of the welcome home setting and allows a user to change the welcome home setting. In some embodiments, when the welcome home setting is enabled, the remote communication device 104 uses location information to determine when to start or display a notification regarding starting a beverage making operation. The location information may be determined based on joining a particular network (such as a WLAN that the beverage appliance 102 is connected to). Alternatively, the location information may be based on proximity to a beacon. The beacon may be integral with or separate from the beverage appliance 102. In yet other embodiments, the location information is based on a location determining technology such as GPS or cellular triangulation available on the remote communication device 104.

The screen alerts slider 1064 indicates the current status of the screen alerts setting and allows a user to change the screen alerts setting. In some embodiments, the screen alerts setting controls whether notification messages such as the notification messages 1030, 1032, 1034, and 1036 are displayed. In some embodiments, additional settings are included to control whether notification messages are displayed outside of the application 114.

The sounds slider 1066 indicates the current status of the sounds setting and allows a user to change the sounds setting. In some embodiments, the sounds setting controls whether the remote communication device 104 makes sounds. In some embodiments, the sound settings controls whether the application 114 makes sounds.

The password slider 1068 indicates the current status of the password setting and allows a user to change the password setting. In some embodiments, the password setting controls whether a user must enter a password to perform various operations on the remote communication device 104. For example, in some embodiments when the password setting is enabled, a user must enter a password to perform one or more of (i) starting the application 114; (ii) starting a beverage making operation; and (iii) modifying a scheduled beverage making operation. Beneficially, by requiring a password to perform certain operations, the remote communication device 104 can be shared with others (such as children) without risk of accidentally starting a beverage making operation.

The default delay selector 1070 indicates the current default delay selected for the remote communication device 104 and allows a user to change the sounds setting. As described previously, in some embodiments, the default delay represents the time period that a brew making operation will be delay by default upon actuation of the delay button 1010 (which is illustrated and described at least with respect to FIG. 16). In some embodiments, upon actuation of the default delay selector 1070, a list of selectable default delay times is displayed.

FIG. 25 illustrates an example appliances screen 1080a displayed on the output device 214 of some embodiments of the remote communication device 104. In some embodiments, the appliances screen 1080a is displayed when the appliances menu option 1052 is actuated on the menu screen 1040 (which is illustrated and described at least with respect to FIG. 23). In some embodiments, the appliances screen 1080a is operated by the remote communication device network configuration component 418. The network configuration screen 1080 is configured to enable a user to set up a communications network between the beverage appliance 102 and the remote communication device 104. In some embodiments, the appliances screen 1080a includes a first button 1082 for looking up available beverage appliances 102 and a second button 1084 for selecting one of the available beverage appliances 102. The example appliances screen 1080a shows no beverage appliances 102 are available to be added or have been added by the user.

FIG. 26 illustrates another example appliances screen 1080b displayed on the output device 214 of some embodiments of the remote communication device 104. The appliances screen 1080b includes a list 1086 of available beverage appliances 102. Specifically, in this example, the list 1086, includes list item 1088 representing a coffee maker and list item 1090 representing a tea kettle. In some embodiments, a user can select an available beverage appliance 102 to establish a network connection as illustrated in FIG. 15. Additionally, in some embodiments, a user can use the appliances screen 1080b to select a beverage appliance 102 to which the remote communication device 104 will direct commands Additionally, in some embodiments, the appliances screen 1080b can be used to disconnect (unpair or forget) a particular beverage appliance 102. In some embodiments, various information related to the beverage appliances 102 (e.g., a nickname, location, usage and maintenance information, etc.) can be viewed or edited (as applicable) using the appliances screen 1080b. Additionally, some embodiments may include additional functionality and interface elements, such as a favorite button to identify particular appliances as favorites that appears at the top of the list 1086.

FIG. 27 illustrates an example schedule management screen 1100 displayed on the output device 214 of some embodiments of the remote communication device 104. In some embodiments, the schedule management screen 1100 is displayed when the schedule beverage menu option 1044 is actuated on the menu screen 1040 (which is illustrated and described at least with respect to FIG. 23). In some embodiments, the schedule management screen 1100 displays a list 1102 of scheduled beverage making operations and an add new button 1116. In this example, the list 1102 includes list item 1104 representing a first scheduled beverage making operation and list item 1106 representing a second scheduled beverage making operation. In some embodiments, each list item includes a label (e.g., labels 1108a, 1108b), an activation slider (e.g., activation sliders 1110a, 1110b), an edit button (e.g., edit buttons 1112a, 1112b), and a favorite button (e.g., favorite buttons 1114a, 1114b). The labels 1108a, 1008b display various information about the scheduled beverage making operation such as a name and the schedule time. The activation sliders 1110a, 1110b indicate whether the scheduled beverage making operation is currently active (enabled) and allow a user to activate/deactivate the scheduled beverage making operation. The edit buttons 1112a, 1112b operate to display a screen for editing a scheduled beverage making operation. The add new button 1116 operates to display a screen for adding a new schedule beverage making operation. In some embodiments, the same screen (which is illustrated and described at least with respect to FIG. 28) is displayed when the edit buttons 1112a, 1112b and the add new button 1116 are actuated. The favorite buttons 1114a, 1114b allow a user toggle whether the scheduled beverage making operation is selected as a favorite by actuating the favorite buttons 1114a, 1114b. Additionally, in some embodiments, the favorite buttons 1114a, 1114b also indicate whether the scheduled beverage making operation is currently set as a favorite (e.g., with a graphical symbol or with a brighter or otherwise different color, etc.). In some embodiments, the application 114 operates to cause the beverage making operations that are selected as favorites to appear at the top of the list 1102.

Additionally, in at least some embodiments, one or more interface elements are combined into a single integral interface element. For example, some embodiments do not include separate edit buttons 1112a, 1112b. In at least some of these embodiments, the labels 1108a, 1108b include actuatable controls, which upon actuation operate to display a screen for editing scheduled beverage making operations.

FIG. 28 illustrates an example edit schedule screen 1120 displayed on the output device 214 of some embodiments of the remote communication device 104. In some embodiments, the edit schedule screen 1120 is displayed when an edit button (e.g., edit buttons 1112a, 1112b) or the add new button 1116 is actuated on the schedule management screen 1100 (which is illustrated and described at least with respect to FIG. 27). In some embodiments, the edit schedule screen 1120 includes a time display 1122, an edit time button 1124, a name entry field 1126, a repeat slider 1128, a repeat schedule selector 1130, a notification sound selector 1132, a snooze default slider 1134, a done button 1136, and a cancel button 1138. In some embodiments, the edit schedule screen 1120 operates to both edit existing scheduled beverage making operations and to add new scheduled beverage making operations. For example, if an existing scheduled beverage making operations the edit schedule screen 1120 will be populated with values corresponding to the scheduled beverage making operation that is being edited. In contrast, if a new scheduled beverage making operation is being added, the edit schedule screen 1120 will not be populated (i.e., the various components will be blank or set to default values).

The time display 1122 operates to display the time of the scheduled beverage making operation. The edit time button 1124 operates to display a screen for adjusting the time of the scheduled beverage making operation.

The name entry field 1126 operates to display the current name of the scheduled beverage making operation. Additionally, a user may enter or modify the name of the scheduled beverage making operation through the name entry field 1126.

The repeat slider 1128 indicates whether the scheduled beverage making operation is configured to repeat and allows a user to change whether the scheduled beverage making operation repeats. The repeat schedule selector 1130 operates to display a current repeat schedule and to allow a user to adjust the repeat schedule for the scheduled beverage making operation. In some embodiments, the repeat schedule selector 1130 shows days of the week (as is illustrated in FIG. 28). Additionally or alternatively, the repeat schedule selector 1130 shows blocks of days (such as weekdays and weekends).

The notification sound selector 1132 operates to display a current notification sound and to allow a user to select a different notification sound for the scheduled beverage making operation. In some embodiments, the notification sound is played when the scheduled beverage making operation begins. Additionally, in some embodiments, the notification sound is played when the scheduled beverage making operation completes.

The snooze default slider 1134 operates to display whether snooze (delay) is enabled and allow a user to enable/disable snooze (delay) for a particular scheduled beverage making operation. In some embodiments, if the snooze default slider 1134 is set to off, the option to delay a scheduled beverage making operation is not presented on the home screen 1000a (the home screen 1000a is illustrated and described at least with respect to FIG. 16).

The done button 1136 operates to save the values entered into the edit schedule screen 1120. In contrast, the cancel button 1138 operates to discard the values entered into the edit schedule screen (e.g., leaving the scheduled beverage making operation unchanged or not adding a new scheduled beverage making operation). In some embodiments, when either the done button 1136 or the cancel button 1138 is actuated the schedule management screen 1100 is displayed (the schedule management screen 1100 is illustrated and described at least with respect to FIG. 27).

In some embodiments, after a scheduled beverage making operation is added or edited using the edit schedule screen 1120, the scheduled beverage making operation is stored in a memory location on the remote communication device 104. In at least some of these embodiments, at the time of the scheduled beverage making operation, the remote communication device 104 transmits an instruction to the beverage appliance 102 to cause the beverage operation to be performed. Further, in some embodiments, the remote communication device 104 transmits an instruction to the beverage appliance 104 to perform the beverage operation prior to the scheduled time of the beverage operation based on an estimated time to complete the beverage operation. Additionally or alternatively, in some embodiments, the scheduled beverage making operation is transmitted to the beverage appliance 102 for storage on the beverage appliance 102 (such as in storage device 210).

The various screens illustrated in FIGS. 8, 9, 11, 12, and 16-28 may include additional or different interface components than those described herein. For example, in some embodiments, some or all of the interface elements (such as buttons, sliders, selectors, etc.) may be replaced by other types of interface elements (such as sliders, buttons, selectors, etc.). Additionally, some embodiments include operate to display only a portion of the screens described herein and to provide only a portion of the functions to described herein. Embodiments are possible that selectively include each possible subset of functionality (and accompanying screens) described herein. The disclosure is expressly not limited to embodiments containing all of the features described herein. Additionally, in some embodiments, the various screens illustrated in FIGS. 8, 9, 11, 12, and 16-28 and the functions that are performed using those screens, may be displayed and performed by the application 114.

Technical effects of the methods, systems, and computer-readable media described herein include at least one of: (a) receiving a user selection to prepare a beverage with a beverage appliance; (b) retrieving and displaying to a user a list of instructions for the user to select from; (c) retrieving and displaying instruction to a user; (d) transmitting beverage appliance settings to a beverage appliance; (e) receiving data from a beverage appliance; (f) alerting a user that a preparing time for a beverage has elapsed; and (g) alerting a user when a beverage has finished being prepared.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Although certain embodiments of this disclosure have been described above with a certain degree of particularity, those skilled in the art could make numerous alterations to the disclosed embodiments without departing from the spirit of scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations particularly as to the position, orientation or use of the disclosure. Joinder references (e.g., attached, coupled, connected, and the like) are to be construed broadly and may include intermediate members between a connection of elements relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the disclosure as defined in the appended claims.

When introducing elements of the present disclosure or the various versions, embodiment(s) or aspects thereof, the articles “a”, “an”, “the” and “said” are intended to mean that there are one or more elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above without departing from the scope of the disclosure, it is intended that all matter contained in the above description and shown in the accompanying drawings shall be interpreted as illustrative and not in a limiting sense.

What is claimed is:

1. A coffee maker comprising:
a heating element;
a reservoir configured to retain a fluid; and
a controller including a communication interface configured to receive instructions from a remote communication device, the controller configured to cause the beverage appliance to perform beverage operations in response to instructions received from the remote communication device.

2. The coffee maker of claim 1, further comprising:
a sensor configured to detect an operational characteristic of the beverage appliance, wherein the sensor is communicatively coupled to the controller.

3. The coffee maker of claim 2, wherein the operational characteristic comprises at least one of temperature data and weight data.

4. The coffee maker of claim 1, wherein the controller is further configured to transmit operational data to the remote communication device.

5. The coffee maker of claim 4, wherein the operational data comprises at least one of a power status, a brewing status, and a temperature setting.

6. The coffee maker of claim 1, wherein the controller is further configured to transmit a signal to the remote communication device upon completion of the beverage operation.

7. The coffee maker of claim 1, wherein the controller is further configured to receive a keep warm instruction from the remote communication device and upon receiving the keep warm instruction causing the heating element to generate heat.

8. The coffee maker of claim 1, wherein the beverage appliance further comprises an indicator configured to indicate a status of the beverage appliance.

9. The coffee maker of claim 8, wherein the controller is configured to alter the indicator based at least in part on the amount of time since the completion of a beverage operation.

10. A method for operating a beverage appliance using a remote communication device, the method comprising:
receiving, on the remote communication device, a selection of at least one setting for a beverage operation using the beverage appliance;
transmitting the at least one setting to the beverage appliance;
receiving at least one of beverage data and operational data from the beverage appliance;
determining when the beverage operation is complete;
generating an alert when the beverage operation is complete; and
displaying, on a display device of the remote communication device, an indicator of the time since the completion of the beverage operation.

11. The method of claim 10, further comprising:
displaying a user interface for scheduling a beverage operation;
receiving schedule information, wherein the schedule information comprises a scheduled time; and
storing the schedule information.

12. The method of claim 11, further comprising:
prior to the scheduled time, displaying an alert that the beverage operation is scheduled;
receiving a delay input, the delay input specifying a duration of time to delay transmitting settings to the beverage appliance to start the beverage operation.

13. The method of claim 12, further comprising:
in response to receiving the delay input:
displaying, on the display device, a plurality of delay time values; and
receiving a selection of a delay time value from the plurality of delay time values.

14. The method of claim 13, further comprising:
displaying, on the display device, one of the delay time values of the plurality of delay time values as pre-selected based on a default delay time value setting; and
receiving an input confirming the selection of the pre-selected delay time value.

15. The method of claim 11, further comprising:
displaying, on the display device, a user interface for displaying and editing at least one scheduled beverage operation, wherein the user interface includes a favorites control that operates to identify the at least one scheduled beverage operation as a favorite scheduled beverage operation.

16. The method of claim 13, further comprising:
displaying, on the display device, a list of scheduled beverage operations including favorites scheduled beverage operations, wherein favorite scheduled beverage operations are ordered ahead of other scheduled beverage operations in the list.

17. The method of claim 10, wherein the instructions further cause the processor to:
display, on the display device, a progress indicator to indicate progress toward completion of a beverage operation.

18. A computer-readable storage medium storing computer-executable instructions that, when executed by a processor of a remote communication device, cause the remote communication device to:
receive a selection of at least one setting for the beverage operation using the beverage appliance;
transmit at least one setting to the beverage appliance;
receive at least one of beverage data and operational data from the beverage appliance;
determine when the beverage operation is complete;
display an alert when the beverage operation is complete; and
display an indicator of the time since the completion of the beverage operation.

19. The computer-readable storage medium of claim 18, wherein the instructions further cause the remote communication device to:
access a list of scheduled beverage operations;
prior to a scheduled time of a scheduled beverage operation, display an alert related to the scheduled beverage operation.

20. The computer-readable storage medium of claim 18, wherein the instructions further cause the remote communication device to:
if a delay input has not been received, at the scheduled time of the scheduled beverage operation, transmit an instruction to the beverage appliance to start the beverage operation.
